(19) United States
(12) Patent Application Publication
(10) Pub. No.: US 2015/0084838 A1
(43) Pub. Date: Mar. 26, 2015

(54) Public Signage

(71) Applicant: AT&T Intellectual Property I, L.P., Atlanta, GA (US)

(72) Inventors: Hisao M. Chang, Cedar Park, TX (US); Dimitrios Dimitriadis, Rutherford, NJ (US); Bernard S. Renger, New Providence, NJ (US); Eric Zavesky, Austin, TX (US)

(73) Assignee: AT&T Intellectual Property I, L.P., Atlanta, GA (US)

(21) Appl. No.: 14/033,853

(22) Filed: Sep. 23, 2013

(51) Int. Cl. G06F 3/14; H04L 29/08

(52) U.S. Cl. CPC G06F 3/1454; H04L 67/02
USPC 345/2.1

(57) ABSTRACT

A network of intelligent electronic public signs interacts with one or many devices. A central server manages the electronic public signs and determines which one of the electronic public signs should display content related to a device. The central server may thus pair devices to electronic public signs for public display of individual content requests. Should any interaction involve personal or private information, the central server may exclude the corresponding response from public display. Any personal or private interactions may, instead, be privately conducted to prevent public display.

### COPYRIGHT NOTIFICATION

A portion of the disclosure of this patent document and its attachments contain material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### BACKGROUND

Video displays are common in public spaces. New York's Times Square, for example, has many large electronic signs that advertise products and services. Electronic signage is also found in stores and in stadiums. Conventional public signage, though, lacks an ability to publically interact with the people observing the public signage.

### BRIEF DESCRIPTION OF THE SEVERAL VIEWS OF THE DRAWINGS

The features, aspects, and advantages of the exemplary embodiments are understood when the following Detailed Description is read with reference to the accompanying drawings, wherein:

FIGS. 1-3 are simplified schematics illustrating an environment in which exemplary embodiments may be implemented;

FIG. 4 illustrates dual-formatting, according to exemplary embodiments;

FIGS. 5-6 are schematics illustrating an alternate environment in which exemplary embodiments may be implemented;

FIG. 7 is a more detailed schematic illustrating the operating environment, according to exemplary embodiments;

FIG. 8 is a schematic illustrating a registration process, according to exemplary embodiments;

FIGS. 9-11 are schematics illustrating location-based pairing, according to exemplary embodiments;

FIG. 12 is a schematic illustrating network pairing, according to exemplary embodiments;

FIG. 13 is a schematic illustrating alternative pairing schemes, according to exemplary embodiments;

FIG. 14 is a schematic illustrating display instructions, according to exemplary embodiments;

FIG. 15 is a schematic illustrating a search for a closest electronic public sign, according to exemplary embodiments;

FIG. 16 is a schematic illustrating queuing of responses, according to exemplary embodiments;

FIG. 17 is a schematic illustrating signage services, according to exemplary embodiments;

FIG. 18 is a schematic illustrating proactive content, according to exemplary embodiments;

FIG. 19 is a schematic illustrating an upload of content, according to exemplary embodiments;

FIG. 20 is a schematic illustrating content blocking, according to exemplary embodiments;

FIG. 21 is a schematic illustrating privacy settings, according to exemplary embodiments;

FIG. 22 is a schematic illustrating requested hand-offs, according to exemplary embodiments;

FIG. 23 is a schematic illustrating availability, according to exemplary embodiments;

FIG. 24 is a schematic illustrating a common response, according to exemplary embodiments;

FIGS. 25-27 are schematics further illustrating the common response, according to exemplary embodiments;

FIG. 28 is a schematic illustrating an alternate operating environment, according to exemplary embodiments; and

FIGS. 29-30 depict still more operating environments for additional aspects of the exemplary embodiments.

### DETAILED DESCRIPTION

The exemplary embodiments will now be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the exemplary embodiments to those of ordinary skill in the art. Moreover, all statements herein reciting embodiments, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating the exemplary embodiments. The functions of the various elements shown in the figures may be provided through the use of dedicated hardware as well as hardware capable of executing associated software. Those of ordinary skill in the art further understand that the exemplary hardware, software, processes, methods, and/or operating systems described herein are for illustrative purposes and, thus, are not intended to be limited to any particular named manufacturer.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, etc. may be used herein to describe various elements, these elements should not be limited by these terms. These terms are only used to distinguish one element from another. For example, a first device could be termed a second device, and, similarly, a second device could be termed a first device without departing from the teachings of the disclosure.

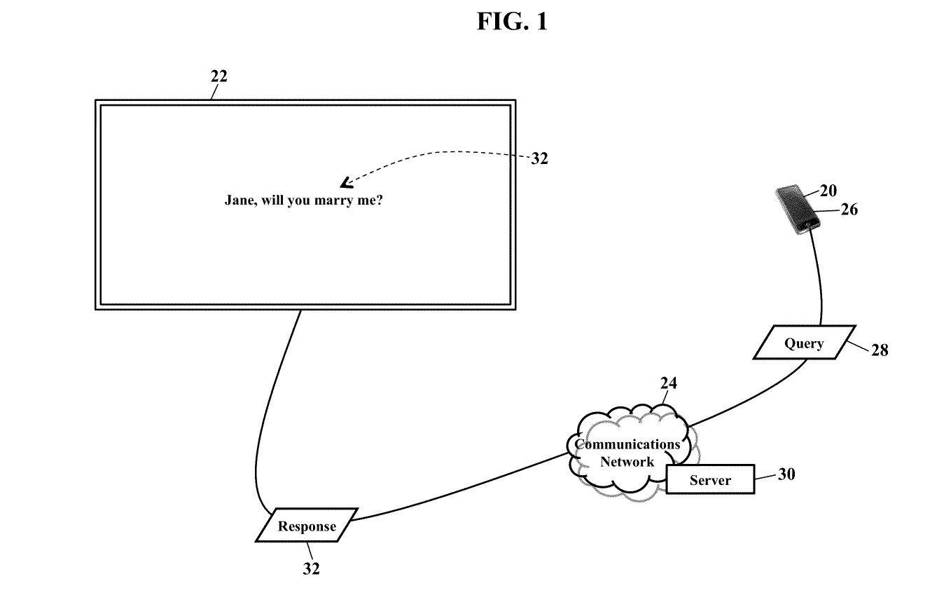

FIGS. 1-4 are simplified schematics illustrating an environment in which exemplary embodiments may be implemented. FIG. 1 illustrates a mobile device 20 that interacts with an electronic public sign 22 using a communications network 24. The mobile device 20, for simplicity, is illustrated as a smart phone 26, but the mobile device 20 may be any mobile or stationary processor-controlled device (as later paragraphs will explain). As a user of the mobile device 20 stands before the electronic public sign 22, the user may wish to interact with the electronic public sign 22. The user may thus cause the mobile device 20 to submit a query 28 for some information. The user, for example, may wish to obtain a news article, product information, or an answer to a question. Whatever the query 28, the query 28 routes along the communications network 24 to a server 30. The server 30 retrieves a response 32 to the query 28, and the server 30 sends the response 32 to a network address associated with the electronic public sign 22. The electronic public sign 22 thus publically displays the response 32 to the user's query 28. The response 32, in other words, is publically displayed for all to see and hear. The electronic public sign 22 may be any display device using any technology, such as LED, LCD, and Plasma components.

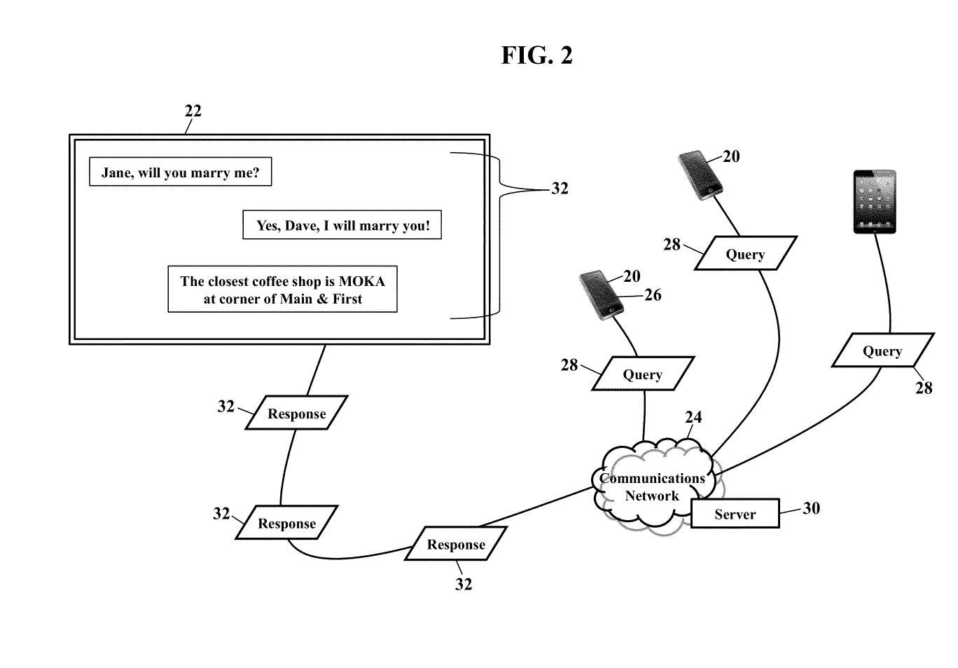

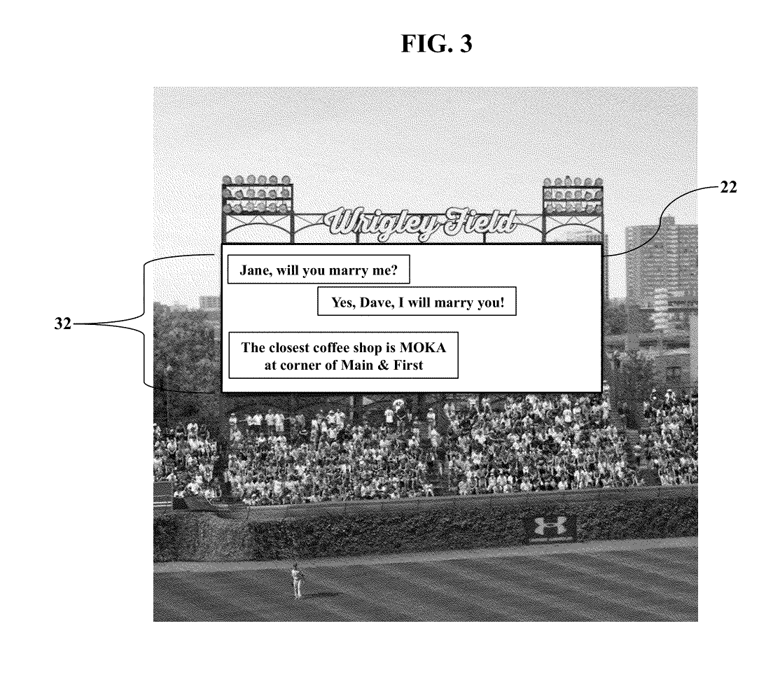

FIGS. 2-3 illustrate multiple users interacting with the electronic public sign 22. Public environments will have many people who wish to interact with the electronic public sign 22. FIG. 2, then, illustrates several queries 28 sent from mobile devices 20 crowded around the electronic public sign 22. The queries 28 route along the communications network 24 to the network address associated with the server 30. The server 30 retrieves the various responses 32 to the queries 28. The server 30 sends the responses 32 to the network address associated with the electronic public sign 22.

FIG. 3 further illustrates public display of the responses 32. FIG. 3 illustrates the electronic public sign 22 as a large screen display at a baseball field. As crowds gather in public places, the mobile devices (not shown) in the crowd submit the queries (illustrated as reference numeral 28 in FIGS. 1-2), and the electronic public sign 22 displays each response 32. Multiple people in the crowd, using their respective mobile devices, may thus submit queries, and the various responses 32 are publically displayed for the crowd to observe.

Exemplary embodiments thus extend social interactions. The electronic public sign 22 allows multiple, mobile devices 20 to share a single, public display. Individual users may request advertisements, stock quotes, driving/walking directions, movie clips, websites, or any other information or content. Whatever the query request, the different queries 28 may be simultaneously processed so that each response 32 is publically displayed by the electronic public sign 22. Exemplary embodiments thus provide simultaneous interactions between multiple devices 20 and the single electronic public sign 22.

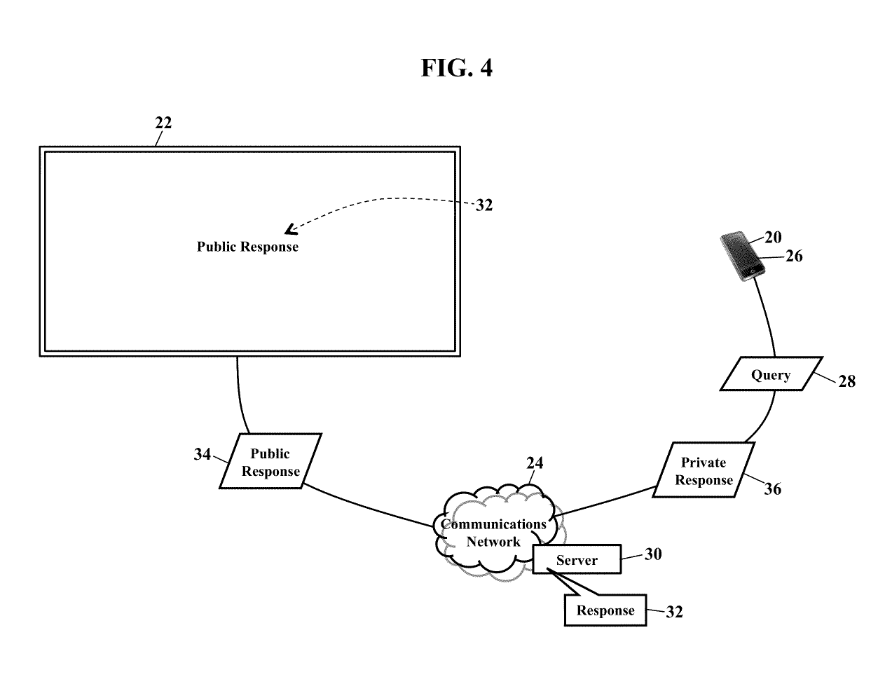

FIG. 4 illustrates dual-formatting of the response 32, according to exemplary embodiments. When the user's mobile device 20 submits the query 28, two or more versions of the response 32 may be generated. FIG. 4 thus illustrates a public response 34 and a private response 36. The public response 34 is sent to the network address associated with the electronic public sign 22. The private response 36, however, may be sent to the network address associated with the mobile device 20. That is, the public response 34 is processed and/or formatted for the size and capabilities of the electronic public sign 22. The private response 36 may be separately processed and/or formatted for the size and capabilities of the mobile device 20. The server 30 may query for, retrieve, or be informed of the capabilities of the electronic public sign 22 (such as its model, display size, video capabilities, and other performance characteristics). The server 30 may, likewise, obtain the capabilities of the mobile device 20 (such as its model, display screen size, video capabilities, and other performance characteristics). Exemplary embodiments may thus generate the different, but dual-responses 34 and 36, one for public consumption and another one for private consumption.

The dual-formatting is further explained. When the response 32 is determined, the public response 34 and the private response 36 may have the same, or nearly the same, content. That is, the public response 34 and the private response 36 may be nearly identical (perhaps a copy) and nearly simultaneously sent to two different destinations (e.g., the mobile device 20 and the electronic public sign 22). The private response 36, however, may have less content than the public response 24, as the mobile device 20 will likely have a much smaller display screen. The private response 36 may thus be formatted to abbreviate, redact, reduce, and/or trim the content to suit wireless bandwidth and screen size.

The dual-formatting may also reflect public/private considerations. When the mobile device 20 submits the query 28, some portions of the response 32 may be desirable or appropriate for public consumption. Other portions, however, may be private. For example, some portions of the response 32 may contain names, images, or account numbers that the user does not wish to be publically displayed. Some portions of the response 32 may contain content that is inappropriate for public display (such as violence and nudity). So, when the response 32 is generated, the server 30 may generate the public response 34 for public display by the electronic public sign 20. Not only may the public response 34 be formatted for the electronic public sign 20, but the public response 34 may be redacted and/or sanitized for public consumption. The server 30 may format the public response 34 to hide or remove names, social security numbers, images, and any other personal/private information. The server 30 may even remove content that is deemed socially offending. The private response 36, however, may retain any information that is private or offensive. The server 30 may thus implement dual formatting to simultaneously resolve public and private considerations. This disclosure will discuss personal/private concepts in later paragraphs.

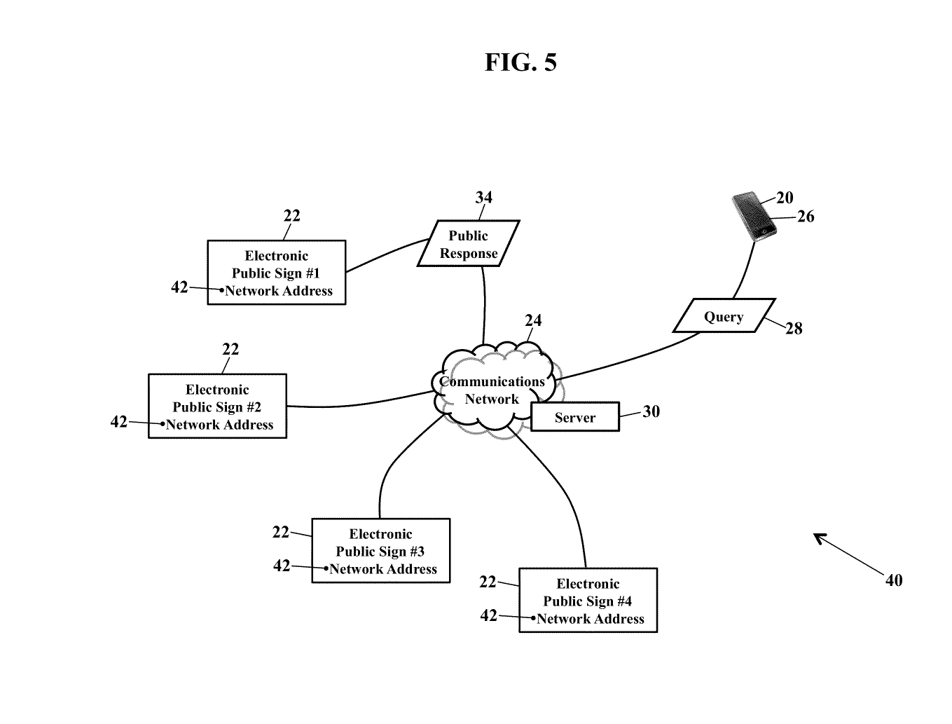

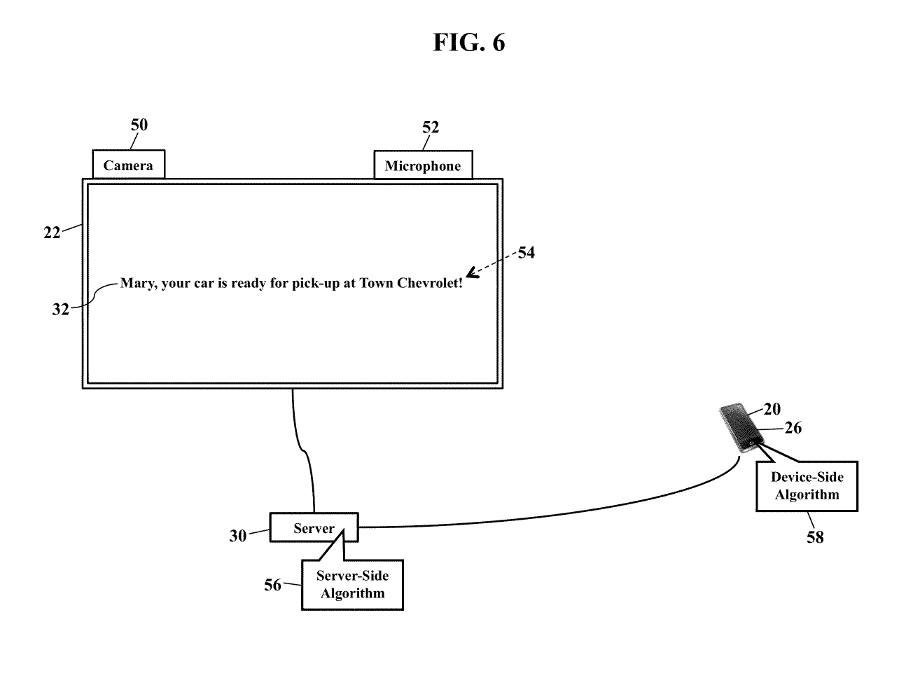

FIGS. 5-6 are schematics illustrating an alternate environment in which exemplary embodiments may be implemented. Here there are several electronic public signs 22 communicating with the server 30 and with the communications network 24. That is, the server 30 may control a network 40 of the electronic public signs 22. Each individual electronic public sign 22 has its own corresponding, unique network address 42. Whatever the query 28, the corresponding public response 34 may thus be sent to any network address 42 of any electronic public sign 22 in the network 40. This addressability enhances many services and features, which later paragraphs will explain.

FIG. 6 illustrates one or more cameras 50 and microphones 52. As users pass by, or gather around, the electronic public sign 22 may interact with the users based on speech inputs, touch inputs, and/or gesture inputs. The camera 50 and/or the microphone 52 enable exemplary embodiments to respond to the users' speech inputs and their gestures. Exemplary embodiments may simultaneously process any inputs from multiple mobile devices. That is, the mobile device 20 may also control the interaction on the electronic public sign 22 using speech and touch. The audio/video sources displayed on the electronic public sign 22 may be used in conjunction with the inputs from the mobile device 20 to manage and optimize the interaction and handoff back and forth between the mobile device 20 and the electronic public sign 22. At the same time, the audio/video sensors built into the electronic public sign 22 are watching and hearing who is speaking into their mobile device 20, which is in sync with the content 54 displayed by the electronic public sign 22.

Exemplary embodiments may be cloud-based. The central server 30 may process any interactions between the mobile device 20 and the electronic public sign 22. The central server 30 may execute a server-side algorithm 56, which may function has a virtual service agent. Each mobile device 20 may execute a device-side algorithm 58. The synchronization between different instances of the same mobile application used by different users in front of different electronic public signs 22 allows the virtual service agent to send back the customized responses 32 in real time or nearly in real time. Any microphones on the mobile devices 20 enable the virtual service agent to receive high-quality speech input while the far-field video/microphone array subsystem 50, 52 enables the virtual service agent to determine which user is speaking and when the user has finished speaking. The network 40 of the electronic public signs 22 may thus provide a cloud-based service operated through a number of geo-distributed electronic public signs 22 networked together and controlled by one or more speech-enabled and vision-enabled virtual service agents. Each virtual service agent may control the electronic public signs 22 for a set of products from a retail merchant (e.g., MACY'S®, HOME DEPOT®, and AMAZON®).

The mobile devices 20 interact with the electronic public sign 22. The centralized virtual service agent software system allows users in front of the electronic public sign 22 to interact directly or indirectly through modalities such as voice inputs, screen touches, hand gestures, and/or facial expressions. Direct interaction with the virtual service agent can be accomplished though speech, gestures, and any other inputs captured by the microphone 52, camera 50, and other sensors locally attached to the electronic public sign 22. Indirect interaction with the virtual service agent can be similarly captured by the device-side algorithm 58 running on the user's mobile device 20. These interactions may be personified using a 3D human-like avatar displayed on the electronic public sign 22 or voiced through attached media systems. Exemplary embodiments may intelligently switch between direct and indirect interactions according to privacy/personal settings and modality needs of the user (in crowded settings, some users may not feel comfortable speaking into the microphone 52 built into the electronic public sign 22). Any inputs made to the mobile device 20 may be sent into the communications network and processed to control the electronic public sign 22.

Exemplary embodiments provide many conveniences. The user of the mobile device 20 may query for, retrieve, and publically share product and service information. For example, a mobile user standing in a long line at a movie theater ticketing office may want to know about movie choices of other people in front of the line. Similarly, knowing about popular purchases or being able to identify the recent purchase of other shoppers at a department store would be very valuable to both the consumer looking for similar merchandise and the retailer, who can garner additional sales, simply by informing other shoppers in a convenient and personalized way. The electronic public sign 22 thus allows simultaneous, multiple user interactions using their respective mobile devices 20. In addition, the small display screen on the smart phone 26 and other mobile devices 20 is a limiting factor when looking for physical products and their actual sizes for product comparisons. Moreover, slow data connections are exacerbated in a crowded indoor space such as a shopping mall where the over-the-air bandwidth is limited. The electronic public sign 22, instead, can have fast wired network connections that relieve congestion and bottlenecks in wireless networks.

Exemplary embodiments benefit retailers. The network 40 of the electronic public signs 22 allows a retail operator to provide a variety of time sensitive and location-specific product information to targeted consumers who are near one of the electronic public signs 22. Each electronic public sign 22 may include, or interface with, sensors to detect human activities when consumers are approaching. An optional 3D human-like digital avatar, for example, may proactively invite people to interact with the electronic public sign 22, either directly or indirectly, via their mobile device 20. For example, the electronic public sign 22 may have components and/or capabilities to monitor the number of people in a pre-defined proximity using facial detection and tracking technology analyzing video feeds from the one or more video cameras 50. Should a face be detected, additional demographic (age, gender, etc.) and appearance (smiling, frowning, inquisitive) attributes may be computed and attributed to the user. These attributes may be used to personalize tasks for a more specific and accurate interaction. Should a user indicate a potential interest in the content displayed on the electronic public sign 22 (e.g., looking at the screen for more than three seconds), exemplary embodiments may optionally activate the 3D human-like avatar to speak to the engaged user and seek their interaction.

Exemplary embodiments facilitate mobile interactions. The user of the mobile device 20 may download the device-side algorithm 58 from common application stores. Each electronic public sign 22 is uniquely identified and may visually scan the users' mobile devices 20 for passive interaction registration. Passive interaction registration also allows users to uniquely identify themselves without speaking, typing, or submitting the query 28. To facilitate this registration, the user launches the device-side algorithm 58 and orients the display of the mobile device 20 towards the electronic public sign 22. The camera 50 interfacing with the electronic public sign 22 may identify a unique visual code displayed by the mobile device 20. A session may then be initiated for interaction with the electronic public sign 22.

The central server 30 may thus mediate the interactions. The server 30 may mediate the interactions locally and at larger scopes within the network 40 of the electronic public signs 22. Information may be passed to any of the electronic public signs 22 in the network 40 and to any mobile device 20. Exemplary embodiments may thus hand-off content between the electronic public signs 22 and the mobile device 20, as later paragraphs will explain. Content may thus follow the mobile device 20 whether displayed by a small in-store display, by a large sign in a public space, or by the user's mobile device 20. This hand-off, for example, may transfer content from a small sign at a checkout register to a larger sign near products for a virtual showroom of a product. That is, advertisements may move from tablet size that has some shirt visuals to a life-size display that allows augmented reality to replace the shirt with a new design. Similarly, if a store has three signs along a walkway, the network 40 may update content to guide a user to his/her product's location in the store (e.g., large directional arrows may be displayed to lead the user where to walk to a desired product). This network-centric capability allows interactions with mobile devices 20 that have only one input type (like audio-only capture/playback devices that operate as virtual assistants).

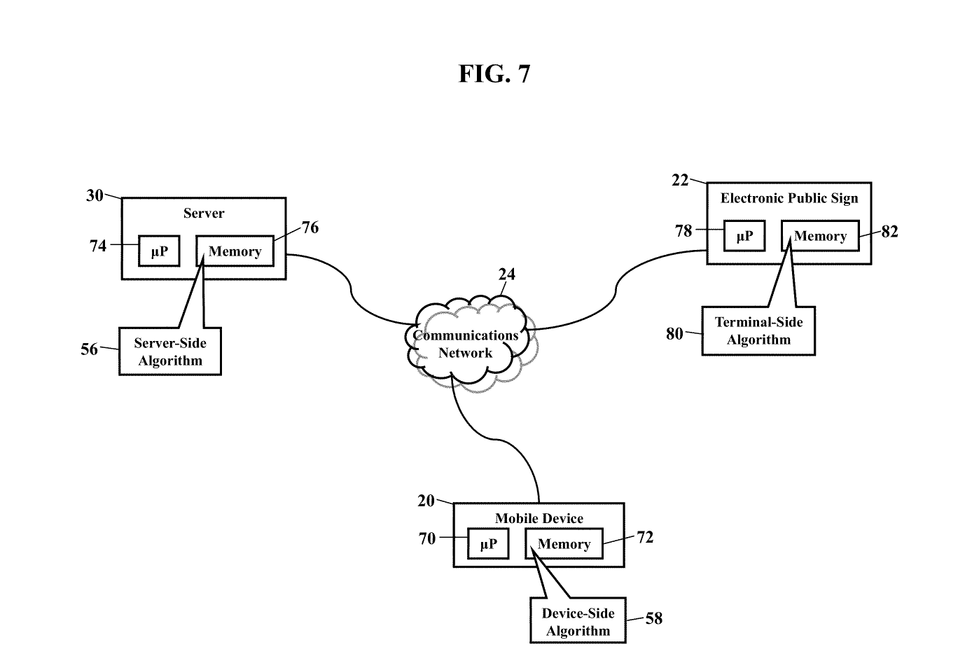

FIG. 7 is a more detailed schematic illustrating the operating environment, according to exemplary embodiments. The mobile device 20 may have a processor 70 (e.g., “μP”), application specific integrated circuit (ASIC), or other component that executes the device-side algorithm 58 stored in a local memory 72. The server 30 may also have a processor 74 (e.g., “μP”), application specific integrated circuit (ASIC), or other component that executes the server-side algorithm 56 stored in a local memory 76. The electronic public sign 22 is an intelligent terminal that may communicate with the mobile device 20 and/or with the server 30. The electronic public sign 22 may thus also have a processor 78 (e.g., “μP”), application specific integrated circuit (ASIC), or other component that executes a terminal-side algorithm 80 stored in a local memory 82. The device-side algorithm 58, the server-side algorithm 56, and the terminal-side algorithm 80 may thus include instructions, code, and/or programs that cooperate in a server-client relationship, via the communications network 24, to publically display content on the electronic public sign 22.

Exemplary embodiments may be applied regardless of networking environment. As the above paragraphs mentioned, the communications network 24 may be a wireless network having cellular, WI-FI®, and/or BLUETOOTH® capability. The communications network 24, however, may be a cable network operating in the radio-frequency domain and/or the Internet Protocol (IP) domain. The communications network 24, however, may also include a distributed computing network, such as the Internet (sometimes alternatively known as the “World Wide Web”), an intranet, a local-area network (LAN), and/or a wide-area network (WAN). The communications network 24 may include coaxial cables, copper wires, fiber optic lines, and/or hybrid-coaxial lines. The communications network 24 may even include wireless portions utilizing any portion of the electromagnetic spectrum and any signaling standard (such as the IEEE 802 family of standards, GSM/CDMA/TDMA or any cellular standard, and/or the ISM band). The communications network 24 may even include power line portions, in which signals are communicated via electrical wiring. The concepts described herein may be applied to any wireless/wireline communications network, regardless of physical componentry, physical configuration, or communications standard(s).

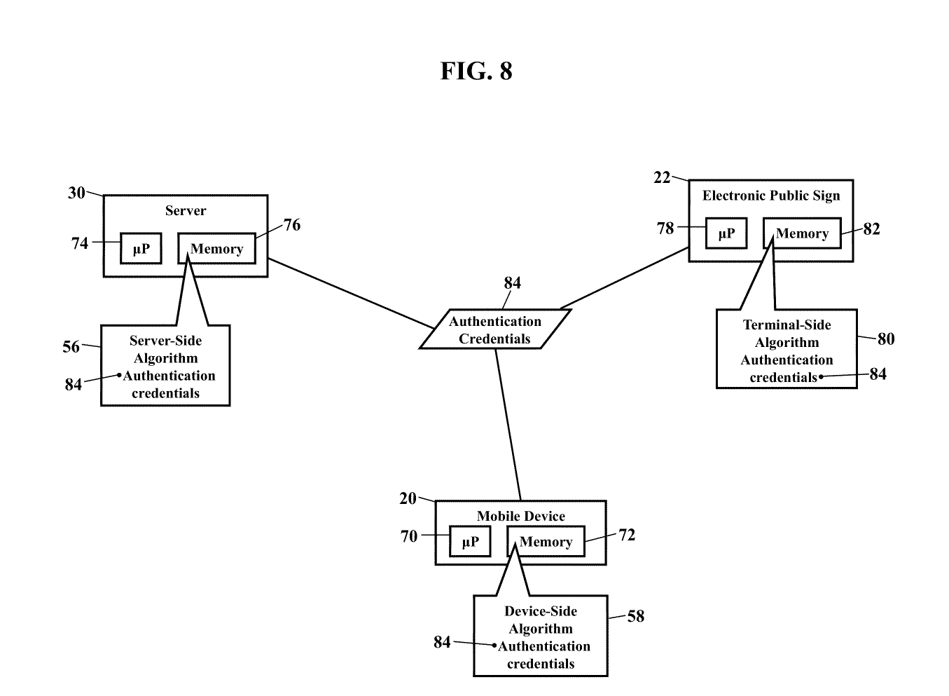

FIG. 8 is a schematic illustrating a registration process, according to exemplary embodiments. The mobile device 20 may register to have content publically displayed by the electronic public sign 22. The mobile device 20 may authenticate by sending authentication credentials 84 to the network address associated with the server 30 and/or with the electronic public sign 22. If the authentication credentials 84 are verified, the server 30 may authorize the electronic public sign 22 to display content associated with the mobile device 20. Exemplary embodiments may utilize any authentication scheme. As many authentication schemes are known, no further details are needed.

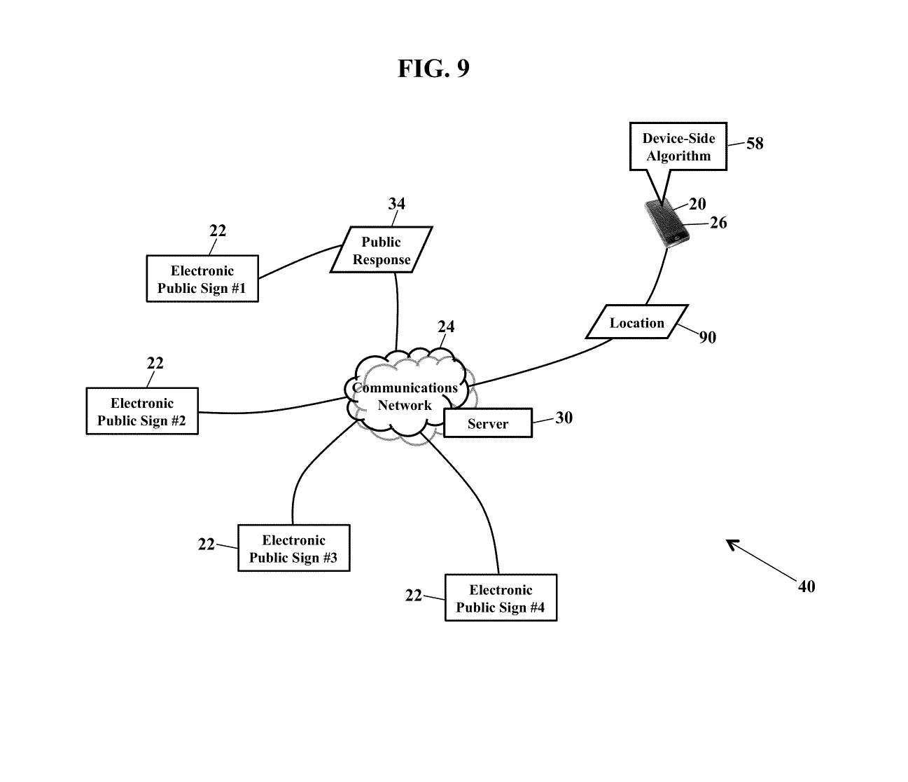

FIGS. 9-11 are schematics illustrating location-based pairing, according to exemplary embodiments. Even though the mobile device 20 has registered with the server 30, the correct electronic public sign 22 must be chosen. As this disclosure explains above, there may be many electronic public signs in the network 40. Exemplary embodiments may thus determine which of the electronic public signs 22 should display the response 32 associated with the mobile device 20. If the mobile device 20 is geographically located in New York's Times Square, but the response 32 is displayed in Chicago's Wrigley Field, then the response 32 is likely meaningless to the user. Exemplary embodiments thus determine which electronic public sign 22 in the network 40 should be paired with the mobile device 20.

Pairing, then, may be based on the location 90 of the mobile device 20. The server 30 may obtain the current location 90 associated with the mobile device 20. The current location 90, for example, may be the Global Positioning System coordinates of the mobile device 20. The device-side algorithm 58 may cause the mobile device 20 to send its GPS coordinates to the server 30. Once the mobile device's location 90 is known, the server 30 may select the electronic public sign 22 that matches the location 90.

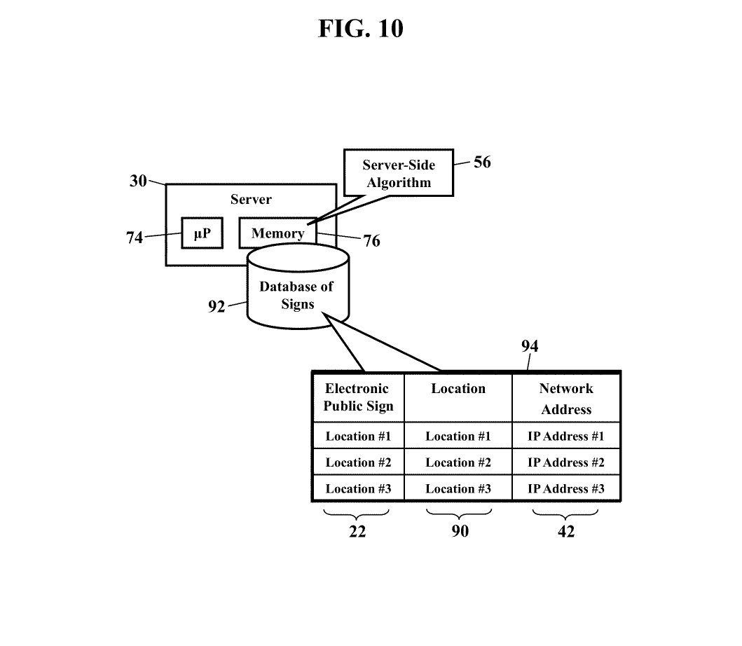

FIG. 10 thus illustrates a database 92 of signs. The database 92 of signs is illustrated as being locally stored in the memory 76 of the server 30, but the database 92 of signs may be remotely maintained and accessed within the communications network 24. The database 92 of signs is illustrated as a table 94 that maps, relates, or associates the different electronic public signs 22 to their corresponding locations 90 and network addresses 42. Each entry in the database 92 of signs may thus be populated with GPS coordinates of the corresponding electronic public sign 22. Once the server 30 obtains the current location 90 of the mobile device 20, the server-side algorithm 56 may query the database 92 of signs for the location 90. If the current location 90 of the mobile device 20 matches one of the locations 90 in the database 92 of signs, the server-side algorithm 56 retrieves the unique network address 42 assigned to the electronic public sign 22 having the closest geographic proximity.

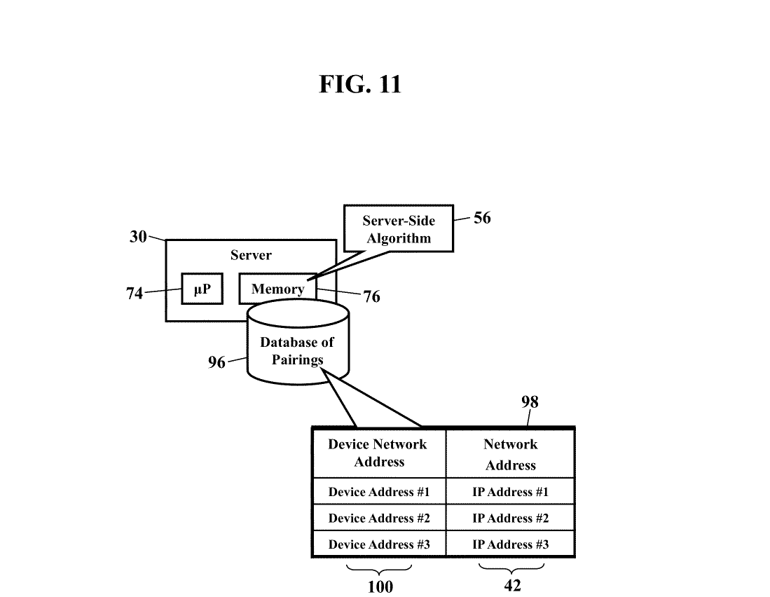

FIG. 11 illustrates a database 96 of pairings. The server-side algorithm 56 may thus store a paired association between the mobile device 20 and the closest electronic public sign 22. The database 96 of pairings is illustrated as a table 98 that maps, relates, or associates a mobile device network address 100 of the mobile device 20 to the network address 42 of the closest electronic public sign 22. The server 30 may thus store this mapping when routing queries and responses associated with the mobile device 20.

Exemplary embodiments may track the mobile device 20. As the mobile device 20 travels, its current location 90 changes. The device-side algorithm 58 may cause the mobile device 20 to randomly or periodically send its GPS coordinates to the server 30. The device-side algorithm 58 may even send the GPS coordinates with each query 28. Regardless, the server 30 may then query the database 92 of signs for the current location 90 of the mobile device 20. So, as the mobile device 20 geographically moves, exemplary embodiments may track the current location 90 and update the database 96 of pairings. Exemplary embodiments thus ensure the public responses 34 are correctly routed to the geographically closest electronic public sign 22.

Location-based tracking is especially advantageous for motorized travel. As the user travels along a highway, for example, the current location 90 of the mobile device 20 may quickly change. The network 40 of the electronic public signs 22 may act as electronic billboards, thus presenting advertising and content as the user travels. The server 30 may thus track the current location 90 of the mobile device 20 and send content to the appropriate electronic public sign 22 along the highway.

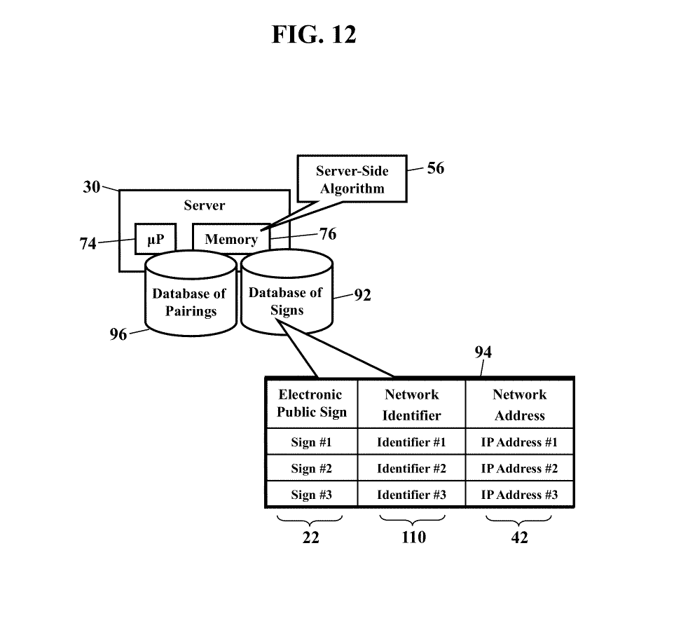

FIG. 12 is a schematic illustrating network pairing, according to exemplary embodiments. Here the database 92 of signs may associate the different electronic public signs 22 to access networks. As most readers understand, mobile devices may utilize a local area network (“LAN”) to send the queries (illustrated as reference numeral 28 in FIGS. 1-6). The LAN, for example, may be a WI-FI® network that is commonly found in public spaces. The LAN, however, may be a BLUETOOTH® network or any other networking standard. Regardless, each local area network may have its own unique network identifier 110. When the mobile device 20 registers with or accesses any local area network, the corresponding network identifier 110 may be sent to the server 30. The server-side algorithm 56 may then query the database 92 of signs for the network identifier 110. If a match is determined, the server-side algorithm 56 retrieves the unique network address 42 assigned to the electronic public sign 22 serving the corresponding local area network. Should the mobile device 20 connect to a WI-FI® network in a public space, for example, the corresponding network identifier 110 may be used to select which electronic public sign 22 (in the network 40) should be paired with the mobile device 20.

Indeed, exemplary embodiments may be applied to any network. Some mobile devices 20 have the capability to access a wide-area network (“WAN”), a cellular access network, or any other networking standard. Whatever the network, the network identifier 110 may uniquely identify any network. When the mobile device 20 registers with or accesses a network, the corresponding network identifier 110 may be sent to the server 30. The database 92 of signs may thus map different BLUETOOTH®, WI-FI®, cellular, and any other networks to their electronic public sign 22 serving the corresponding social space. Once the server 30 obtains the network identifier 110 associated with the mobile device 20, the server-side algorithm 56 may query the database 92 of signs for the network identifier 110. The server-side algorithm 56 retrieves the unique network address 42 assigned to the electronic public sign 22 mapped to the corresponding network. The server-side algorithm 56 may then store the paired relationship in the database 96 of pairings, as explained above.

Social spaces may thus have their own electronic public sign 22. Coffee shops, stores, gyms, and car dealers commonly provide a WI-FI® network for their customers. Even larger venues, such as parks, malls, city squares, and even large stadiums, also provide WI-FI® access for their patrons. Whatever the network, each of the social venues may have one or more electronic public signs 22 displaying content to the public. As crowds gather around the electronic public sign 22, patrons may have their content publically displayed. Exemplary embodiments may thus track and monitor the access LAN/WAN network serving the mobile device 20. The device-side algorithm 58 may randomly or periodically send the corresponding network identifier 110 to the server 30. The device-side algorithm 58 may even send the network identifier 110 with each query 28. Regardless, the server 30 may then query the database 92 of signs for the network identifier 110. The server 30 retrieves the network address 42 assigned to the electronic public sign 22 serving the access LAN/WAN network. As networks are added to public spaces, the database 92 of signs may thus be populated with the corresponding network identifier 110.

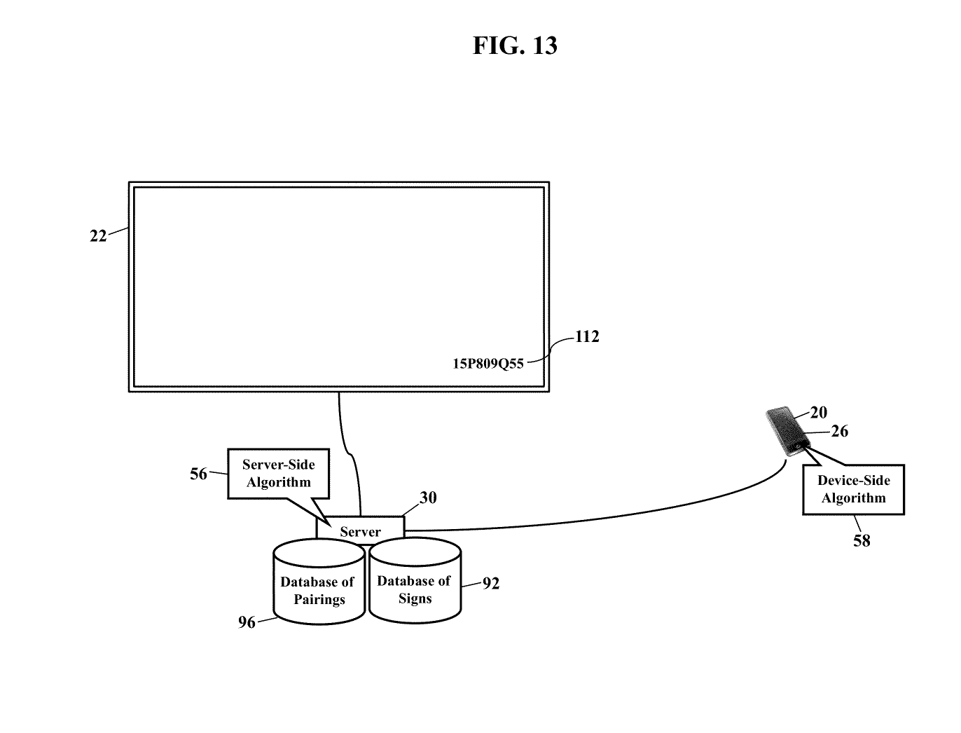

FIG. 13 is a schematic illustrating alternative pairing schemes, according to exemplary embodiments. As the user approaches the electronic public sign 22, the electronic public sign 22 may display a unique terminal identifier 112. The user may enter the unique terminal identifier 112 on a keypad or touch screen, which the device-side algorithm 58 may send to the server 30. The unique terminal identifier 112 may also be a bar code or watermark that is visually displayed and optically obtained by the mobile device 20. The database 92 of signs may store associations between different terminal identifiers 112 and their corresponding network addresses 42. Once the server 30 obtains the terminal identifier 112, the server 30 retrieves the unique network address 42 assigned to the electronic public sign 22 matched to the corresponding terminal identifier 112. The server-side algorithm 56 may then store the paired relationship between the network address 42 of the mobile device 20 and the network address 42 of the electronic public sign 22 serving the social space.

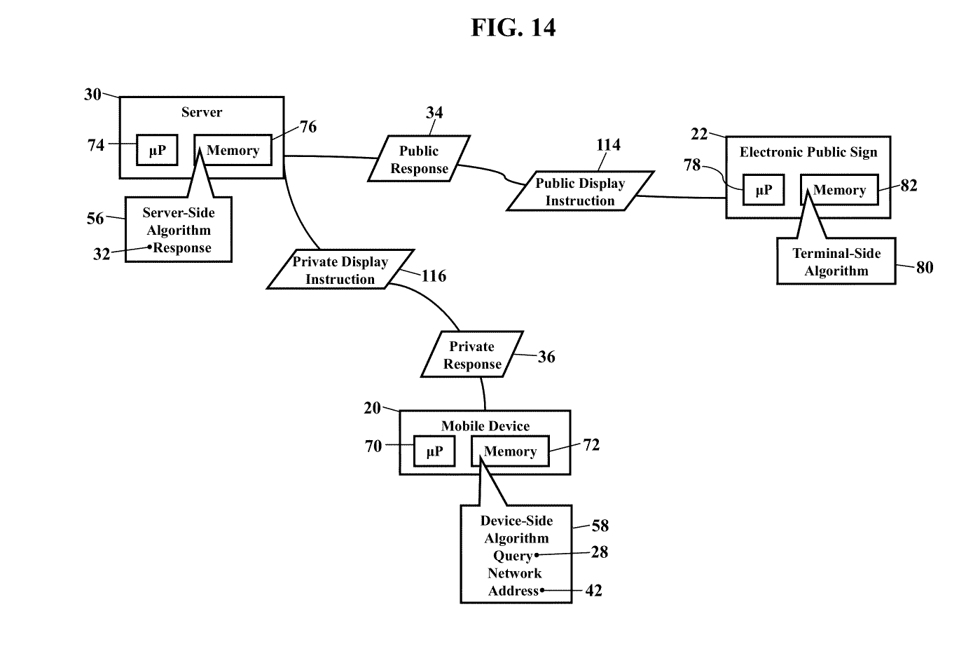

FIG. 14 is a schematic illustrating display instructions, according to exemplary embodiments. However the mobile device 20 is paired with the appropriate electronic public sign 22, instructions may be sent to ensure content is properly displayed. The server 30, for example, may send a public display instruction 114 to the electronic public sign 22. The public display instruction 114 may accompany the public response 34 that is displayed by the electronic public sign 22. The public display instruction 114 may contain any information, command, or code that causes content to be publically displayed on the electronic public sign 22. Because the server 30 may dual-format the response 32, the server 30 may also separately send a private display instruction 116 to the mobile device 20. The private display instruction 116 may provide instructions for privately displaying the private response 36 on the display screen of the mobile device 20.

Display instructions need not be repeated. Once the mobile device 20 is paired to the electronic public sign 22, pairing may be retained. For example, the mobile device 20 may automatically specify the network address 42 of the electronic public sign 22 in any future queries. That is, even though the query 28 may originate from the mobile device 20, the network address 42 of the electronic public sign 22 may be specified as the destination for the public response 34. The network address of the mobile device 20 may be specified as the destination for the private response 36. A web browser, for example, may thus specify two different destination addresses for content requests. Exemplary embodiments may thus remove the server 30 from future transactions (e.g., requests and responses) until the pairing changes or ends.

The display instructions 114 and 116 may also propagate. Because the mobile device 20 is paired to the electronic public sign 22, components operating within the communications network (illustrated as reference numeral 24 in FIGS. 1-2) may be updated. Switches, routers, and other servers may have routing tables updated to map the device network address 100 of the mobile device 20 to the network address 42 of the electronic public sign 22 (as illustrated and explained with reference to FIG. 11). Wherever and whenever the pairing need be reflected, the display instructions 114 and 116 may propagate to the necessary equipment.

Sessions may be initiated once pairing is established. When a user wishes to interact with the electronic public sign 22, a session may be established between the user's mobile device 20 and the server 30 and/or the electronic public sign 22. The session may end when the user no longer desires interaction.

Sometimes the session may automatically end. The session, for example, may end by timing out without interaction. If the user, for example, fails to make inputs or responses to prompts within a window of time, the session may end. If there are multiple people watching the content and the current active user session exceeds a pre-defined threshold in terms of time, exemplary embodiments may conduct a poll in a sidebar portion of the electronic public sign 22. For example, the audience may be prompted to raise their hand (or answer a polling question) if they would like to see a product video about men's running shoes or electronic devices. By counting the hands (the number of people who responded to an onscreen poll using their hand gesture), exemplary embodiments may terminate any active user session and start a new product demonstration cycle based on the consensus of the audience. If this majority-rule occurs, the interactions with any current active user may be moved to a side-bar location on the screen or handed-off to the user's mobile device 20. Thus, the main section of the electronic public sign 22 may be switched to a different context based on the consensus derived from the last poll.

Bookmarks may be saved. Whenever the session ends, exemplary embodiments may store website links and bookmarks to the server 30, to the mobile device 20, and/or to the electronic public sign 22. Links and bookmarks may also be sent to any destination the user prefers. Exemplary embodiments thus allow the user to take information with them and revisit the information and products previously displayed, thus resuming the recent session at another location or another electronic public sign 22 in the network 40. The user can access the same product information (in video, and/or webpages, etc.) from a different location when they are no longer near the electronic public sign 22 using any network connection.

Session records may also be saved. Data regarding each session may be recorded/stored in the server 30, in the mobile device 20, in the electronic public sign 22, or in any other network location. Session records may be saved short-term or long-term. Exemplary embodiments may even aggregate the session records across users. Individual session retention allows the same mobile device 20 to visit a different electronic public sign 22 and resume an earlier user session. Individual session identifiers may also saved until the user deletes them as a running catalog associated with the user's mobile device 20. Thus, a user can interact with an electronic public sign 22 in one department store and then resume the interaction later with a different electronic public sign 22 in a different store in a different shopping mall. When the user interacts with a different electronic public sign 22, the unique session identifier from the previous session may be retrieved and resumed from the session records. Exemplary embodiments may thus know what type of goods/services the user was looking for at the previous electronic public sign 22. As a result, historical interactions, from the same or previous locations, may be resumed, whether thirty minutes or two days ago.

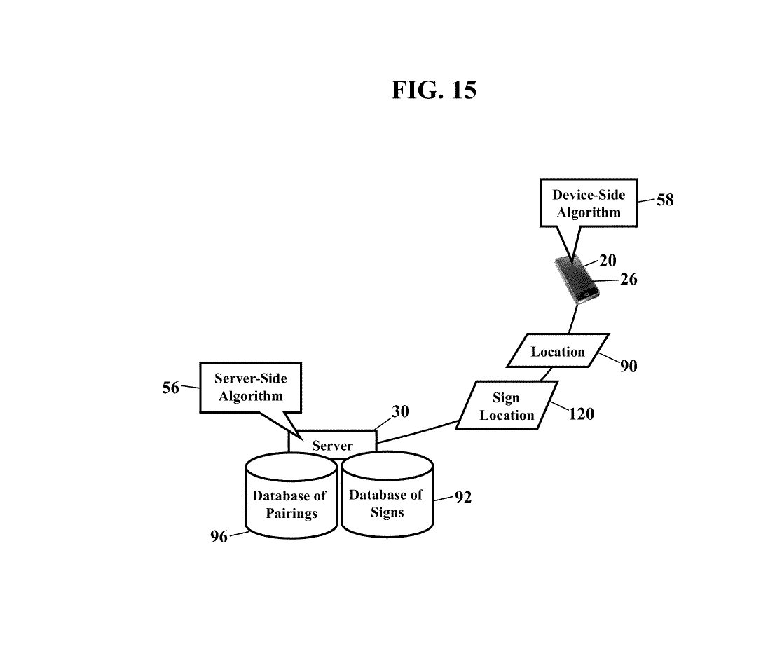

FIG. 15 is a schematic illustrating a search for the closest electronic public sign 22, according to exemplary embodiments. Many users will enjoy public interaction with the electronic public sign 22. Some users, then, may wish to learn the geographic location of the nearest public space offering publically-observable social interactions. FIG. 15 thus illustrates the mobile device 20 again sending its current location 90 to the network address of the server 30. The server-side algorithm 56 queries the database 92 of signs for the current location 90 and retrieves a geographical sign location 120 that maps to the closest electronic public sign 22. The sign location 120 may be stored as GPS coordinates or a physical street address. The server-side algorithm 56 return sends the sign location 120 of the closest electronic public sign 22 to the mobile device 20. The sign location 90 may be visually mapped on a display of the mobile device 20, thus allowing the user to travel to the closest electronic public sign 22.

Alerts may also be sent. When the electronic public sign 22 is encountered, exemplary embodiments may send alerts, advertisements, and other notifications to the user's mobile device 20. The device-side algorithm 58 may have options for opting in, or for opting out, of the alerts. Alerts may be pushed to the mobile device 20 when in proximity of the electronic public sign 22. If the mobile device 20 responds, the device-side algorithm 58 may launch to provide services to the user. Exemplary embodiments, for example, may display a map with directions explaining how to get to the closest electronic public sign 22.

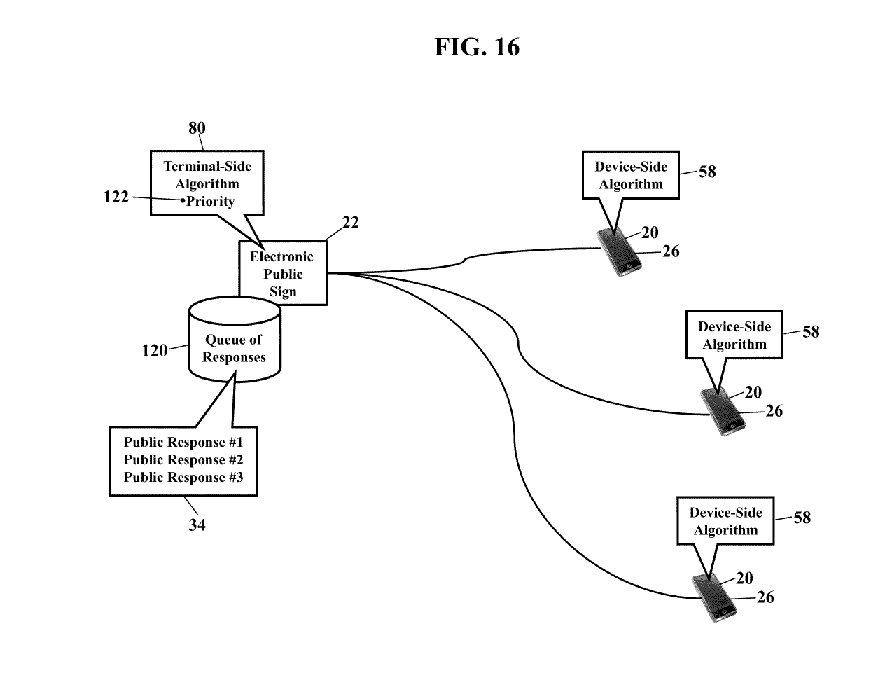

FIG. 16 is a schematic illustrating queuing of different public responses 34, according to exemplary embodiments. Sometimes several mobile devices 20 may be paired to the same electronic public sign 22. Each mobile device 20 is competing with other mobile devices in the same vicinity to have its corresponding public response 34 displayed by the electronic public sign 22. The electronic public sign 22 may thus develop a backlog of content awaiting display. FIG. 16 thus illustrates a queue 120 of responses that may develop. FIG. 16 illustrates the queue 120 of responses stored in the memory (illustrated as reference numeral 82 in FIG. 8) of the electronic public sign 22, but the queue 120 of responses may be remotely maintained at any location in the network 40. Positions in the queue 120 of responses may sequentially advance as content is displayed by the electronic public sign 22. The queue 120 of responses may progress on a first in, first out basis, such that all users' public responses 34 equally progress through the queue 120 of responses according to time of receipt.

Some content, though, may have priority 122. Even though the queue 120 of responses may exist, some content or one of the public responses 32 may advance ahead of other content in the queue 120 of responses. Some advertisers, for example, may have a contractual agreement to have their advertisements immediately advance to a top-most, first position in the queue 120 of responses. Some users may opt to pay a fee to have their public response 34 advance in the queue 120 of responses or to enter the queue 120 of responses at an elevated position. Some content may be public service announcements that receive the priority 122. Some public responses 34 may be emergency-related and advance to a top-most, first position in the queue 120 of responses. The priority 122 may be established based on logical rules according to an originating address and/or a destination address.

The users may also be queued. Should several mobile devices 20 be paired to the same electronic public sign 22, queuing may be applied to the mobile devices 20. The queue 120 of responses may thus progress according to interactions with the multiple mobile devices 20. If an indirect interaction was used to start a session, the positions in the queue 120 of responses may be assigned and sent from the server 30 to the mobile device 20. The queue 120 of responses may be publically displayed by the electronic public sign 22, thus allowing the users in the crowd to gage their time and interest in waiting for public interaction. The queue 120 of responses may additionally or alternatively be sent to the mobile device 20 for private display.

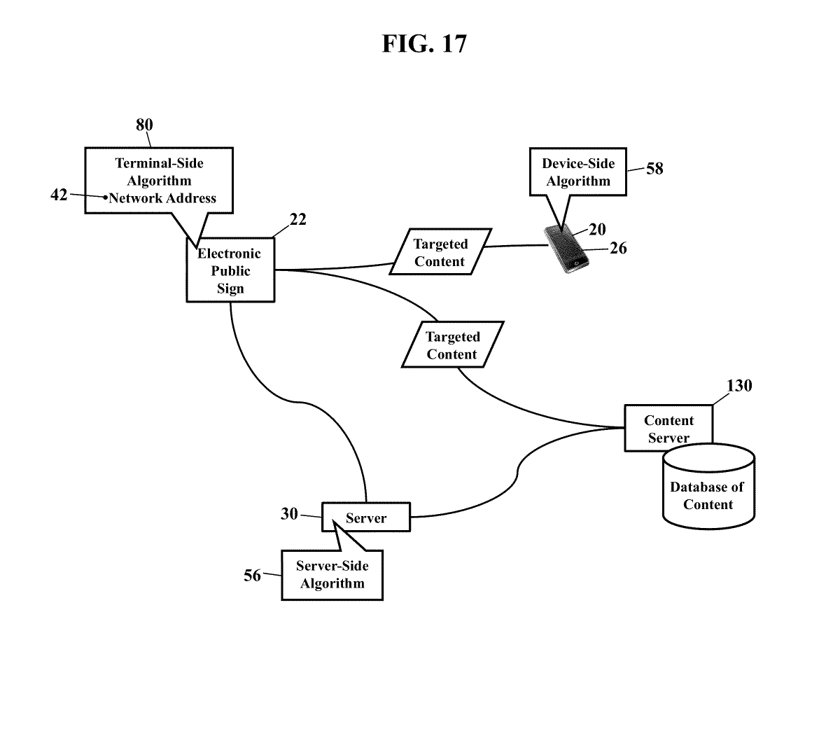

FIG. 17 is a schematic illustrating signage services, according to exemplary embodiments. Once the mobile device 20 is paired to the electronic public sign 22, exemplary embodiments may provide many services and features. Targeted content, for example, may be tailored to the mobile device 20, but the targeted content may be displayed on the electronic public sign 22. Once the mobile device 20 is paired to the electronic public sign 22, advertisements may be publically directed to the mobile device 20. The server 30, for example, may notify a content server 130 of the pairing between the mobile device 20 and the electronic public sign 22. The content server 130 may then send the targeted content to the network address 42 of the electronic public sign 22. The content server 30 retrieves a profile of the mobile device 20 and selects the targeted content that appeals to the profile. The profile may include the current location, time, addresses, demographics, historical selections, purchasing histories, and any other information for profiling the user of the mobile device 20. The content server 30 then sends the targeted content to the electronic public sign 22. The content server 130 may also use the dual-formatting to send targeted content to the mobile device 20. Exemplary embodiments, then, may publically and/or privately display the targeted content, despite being individually tailored to the user of the mobile device 20. Many schemes for recommending and/or targeting content are known, and exemplary embodiments may utilize any scheme.

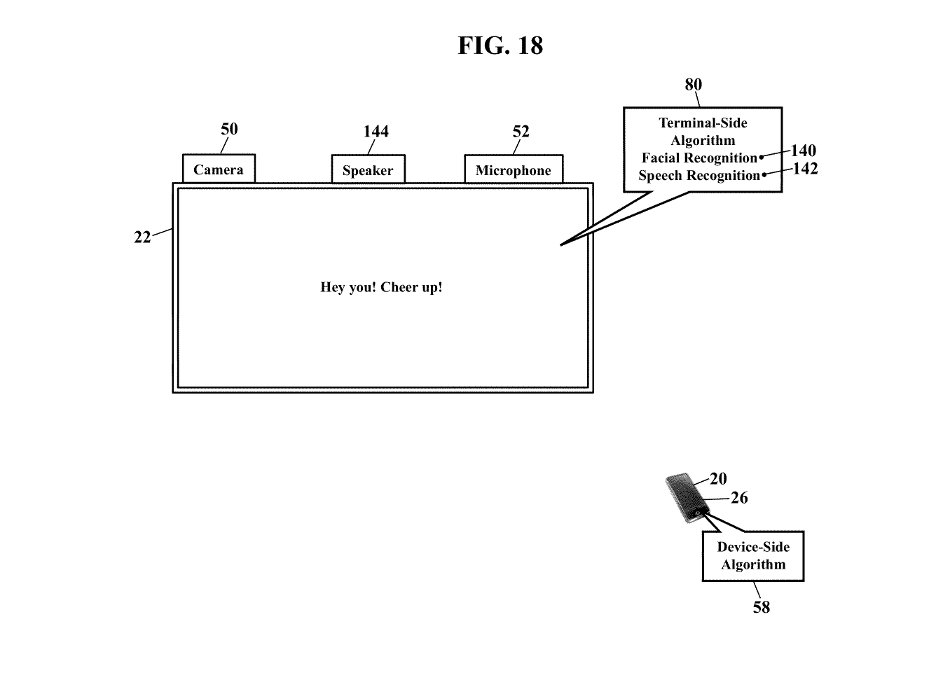

FIG. 18 is a schematic illustrating proactive content, according to exemplary embodiments. Here the electronic public sign 22 may interface with the microphone 52 and/or the camera 50 to further enhance social interactions. The camera 50 may provide visual inputs to the terminal-side algorithm 80, and the microphone 52 may provide audible inputs to the terminal-side algorithm 80. The visual inputs and the audible inputs allow the electronic public sign 22 to interact with humans and mobile devices, even if pairing is not accomplished.

Facial recognition 140 and speech recognition 142 are examples. As people pass by the electronic public sign 22, the terminal-side algorithm 80 may use facial recognition 140 to display advertising and other content. If a face is recognized, content may be displayed that appeals to an identity of the face. Simple recognition techniques may be used to recognize clothing and demographic traits in the crowd. The speech recognition 142 may also be used to discern audio-visual cues from faces, voices, and actions in the visual inputs and in the audible inputs. Content may be selected and publically displayed based on observed behaviors, clothing, colors, and even textures. The bodily positions (e.g., standing or sitting) of people in the crowd, and the volume of their interactions, may indicate mood and other potential advertising opportunities. Observed speech dialects and accents may influence advertising selections. Locations where children and families are know to congregate may display more family-friendly content. The observed pace of people in the crowd (running or strolling) may influence content selections. Observed gazing may indicate interest. Once a face is recognized, demographics and human attributes (such as gender, age bracket, race, and body height/weight and mood) may be determined. Media content may thus be personalized to the user, or the crowd, based on demographics and/or spoken requests from the users in the audience. The electronic public sign 22 may thus proactively display content, based on the cues in the crowd.

Content may be selected, based on cues. When someone passes by the electronic public sign 22, the visual and audio inputs may be used to generate audible content, such as answers to questions. A speaker system 144 may thus output commentary and other audible content to further influence the passerby. “Shout outs” and other audible alerts may be generated to catch someone's attention. The terminal-side algorithm 80 may even suggest public interactions, based on the cues. Products and services may be proactively recommended, again based on the cues in the crowd.

Exemplary embodiments may utilize any cues. Exemplary embodiments may add unique interaction cues based on audio-visual cues. For example, behavioral context may be observed, along with personal context/dress for more precise information. The color of clothing, texture, and material patterns may be used as cues to infer mood. Gate and poise, along with speech dialects/accents, may be used as cues for targeting content. Cues may also be derived from groups of people, such as observed family interactions. Lone, solo persons may also provide cues. The electronic public sign 22 may thus allow more passive interaction with users in both advertising and informational cases. As people walk by, the electronic public sign 22 may enter a certain mode of operation, which may be further modulated by how fast (run, casual stroll, interested gaze at screen) the user passes. The speech recognition 142 capability may also use audio cues to perform the automatic speech recognition 142 and act as an over the shoulder advisor to help provide information. This scenario is more fitting for an information kiosk at a mall, where the user is relieved of the burden of menu navigation by suggesting interactions using audio/video cues. Should a person exhibit stress cues (e.g., behavior/temperament), for example, exemplary embodiments may recommend products for relaxation. The electronic public sign 22 may also engage the crowd with games, such as “Hey! You look like . . . ,” based on face, clothing, or other recognition.

Retailers, of course, may target their content. Advertisers may provide interactive product advertisements targeted to customers using timely and location-specific needs. These needs can be expressed through a number of convenient modalities, like naturally spoken words, touch interaction, and physical gestures, directly or indirectly through the mobile device-side algorithm 58. The electronic public sign 22 may allow the user to engage in a natural language based dialog, with touch-based interactions, or intuitive gestures. The 3D human-like avatar can engage the user during their interaction via the electronic public sign 22 and natural voice audible feedback. The device-side algorithm 58 may also facilitate indirect interaction (speech, touch, gestures), may allow correct routing of information for privacy-sensitive operations, and may provide a passive mechanism for a large number of users to interact with a single display simultaneously. Video and other content used to promote a brand or product is highly dynamic and can be customized based on the actual users who are watching the electronic public sign 22 at any given time. Exemplary embodiments may determine how many viewers at a given time interval are watching the electronic public sign 22 and attempt to engage them.

Exemplary embodiments may also incentivize the interactions. Electronic coupons, deal alerts, and other promotions may be sent to the mobile device 20, perhaps based on the quality of the user's interaction, frequency of use, or other external factors determined by the retail vendor. Rules may thus be stored and associated to interaction metrics, such that the user's interactions are graded or evaluated by comparison to the rules. For example, any user that remains engaged over a period of time watching some ads will be rewarded with a coupon.

The interactions may be crowd sourced. As people gather around the electronic public sign 22, their mobile devices 20 may collaborate for content changes. For example, demographic analysis may reveal that several people have an interest in shoes. This trend may override other content in favor of advertisements for shoes. Content may also be geographically determined (by city, national, or regional considerations), by time (day or year), by global events (e.g., news or weather), and by celebrity spotting/endorsement.

The interactions may also include sensor inputs. As the above paragraphs explained, the mobile device 20 may have GPS capabilities. The mobile device 20, however, may also have a camera, temperature sensor, an inclinometer, a humidity sensor, a light sensor, and any other means of sensing some physical quantity. Whatever the capability, exemplary embodiments may utilize any sensory inputs to further enhance the interactions. Voice inputs and touch inputs, for example, may be combined with ambient measurements (such as temperature, altitude, humidity, ambient light, and ambient sounds), which may help to modulate interactive experiences. The interaction may thus be considered a two-way video conference, allowing the user to request information by spoken request. Exemplary embodiments may connect to a customer representative for the relevant store/product. Exemplary embodiments may also utilize the network camera capture system to facilitate product interactions not possible before; such as returns or purchasing additional product during the returns scenario. When the user returns a product, exemplary embodiments may recognize the product and/or the packaging and starts an RMA ticket. As a simple example, consider when the user returns a light bulb. Exemplary embodiments may display prompts for interactive rotation (turn bulb left, right, upside down) to gather sufficient 3D and other representative data, perform a search of available products for that store, and then identify the same product. This capability helps the user to determine that the light bulb is a forty Watt (40W) green floodlight.

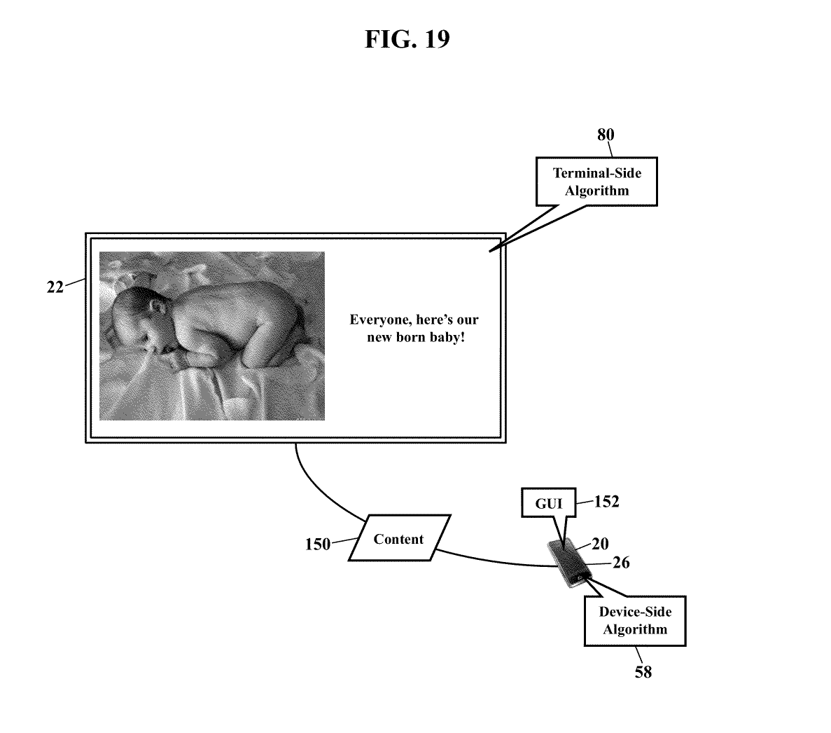

FIG. 19 is a schematic illustrating an upload of content 150, according to exemplary embodiments. Once the mobile device 20 is paired to the electronic public sign 22, the user may upload text, images, files, video, audio, and/or any other content 150 for public display. The device-side algorithm 58, for example, may generate a graphical user interface (“GUI”) 152 that permits selection of files and other content 150 locally stored in the mobile device 20. The graphical user interface 152 may also allow the user to select the content 150 from remote locations. Regardless, once the content 150 is selected, the user may select the electronic public sign 22 as the destination. The device-side algorithm 58 thus causes the mobile device 20 to upload the content 150 into the communications network (illustrated as reference numeral 24 in FIGS. 1-2) for delivery to the electronic public sign 22. Exemplary embodiments, then, permit users to upload and share their own pictures, music, and other content 150 for public display. As an example, the user may upload the content 150 to a website, where a product or information search may be conducted. If a match is found, the response 32 incorporates the desired product information and is displayed by the paired electronic public sign 22. The content 150 may also be emailed to an email account associated with the electronic public sign 22. The content 150 may also be posted to a web site (such as a social media web site) and associated with a tag (such as a hash tag on TWITTER®, for example). The electronic public sign 22 may retrieve any or all messages associated with that tag. The tag may be advertised on the electronic public sign 22, as an email account or a Web site may be advertised. A software application on the mobile device 20 (perhaps calling or executing the device-side algorithm 58 or any other program) may determine how to associate the content 150 (originating from the mobile device 20) with the electronic public sign 22.

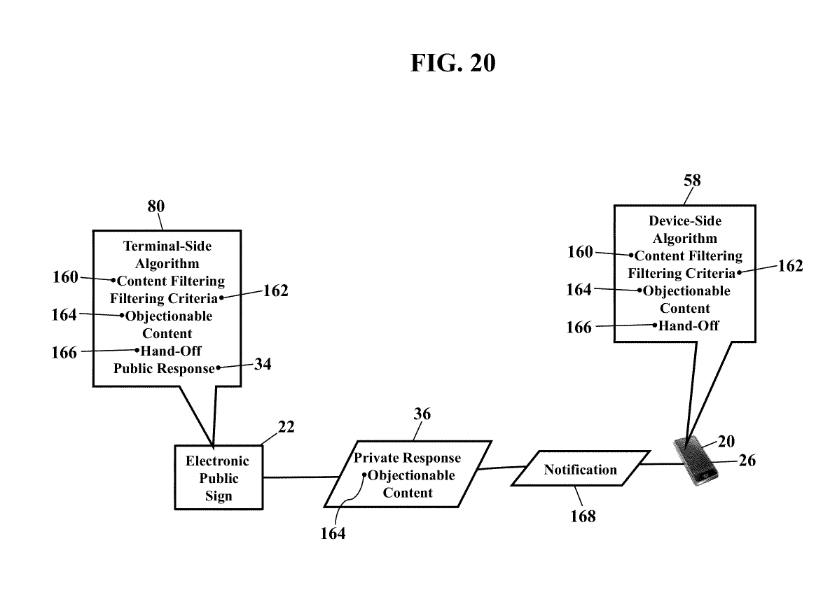

FIG. 20 is a schematic illustrating content blocking, according to exemplary embodiments. As this disclosure earlier explained, some content may be inappropriate for public display. Most public spaces will not want violent, R-rated, or pornographic content publically displayed. The terminal-side algorithm 80, then, may have a content filtering module 160 to help ensure inappropriate content is not publically displayed. The content filtering module 160 may be software, code, or instructions that implements filtering criteria 162 for blocking objectionable content 164. The filtering criteria 162 are configured to suit a town, business, or operator of the public space having the electronic public sign 22. So, should any mobile device 20 in the crowd attempt to publically display inappropriate content, exemplary embodiments may block public presentation. Many content filtering schemes are known, and exemplary embodiments may be adapted to utilize any content filtering scheme. This disclosure, then need not discuss the known schemes.

FIG. 20, though, illustrates a hand-off module 166. The hand-off module 166 may determine when any content should be routed to the mobile device 20, instead of the electronic public sign 22. The hand-off module 166, for example, may intervene and send the objectionable content 164 to the mobile device 20. When the terminal-side algorithm 80 determines, or is informed of, the objectionable content 164, the terminal-side algorithm 80 may invoke the hand-off module 166. The hand-off module 166 may be software, code, or instructions that redirect any content to the mobile device 20, despite the pairing. So, in response to the objectionable content 164, the hand-off module 166 may cause the objectionable content 164 to be routed to the network address of the requesting mobile device 20. A notification 168 may also be sent, informing the user of the mobile device 20 that the objectionable content 164 failed the filtering criteria 162 of the electronic public sign 22. The device-side algorithm 58 may then privately display the objectionable content 164 on the display of the mobile device 20.

Dual-formatting may be used. When the objectionable content 164 is determined, the dual formatting may be used to send the private response 36 to the mobile device 20. The private response 34 may include the objectionable content 164 prohibited or excluded from public display. The electronic public sign 22, instead, receives or generates the sanitized public response 34. The terminal-side algorithm 80 may itself remove the objectionable content 164, or the terminal-side algorithm 80 may receive or process the sanitized public response 34. Again, dual-formatting allows exemplary embodiments to satisfy the user's content desires without offending social norms.

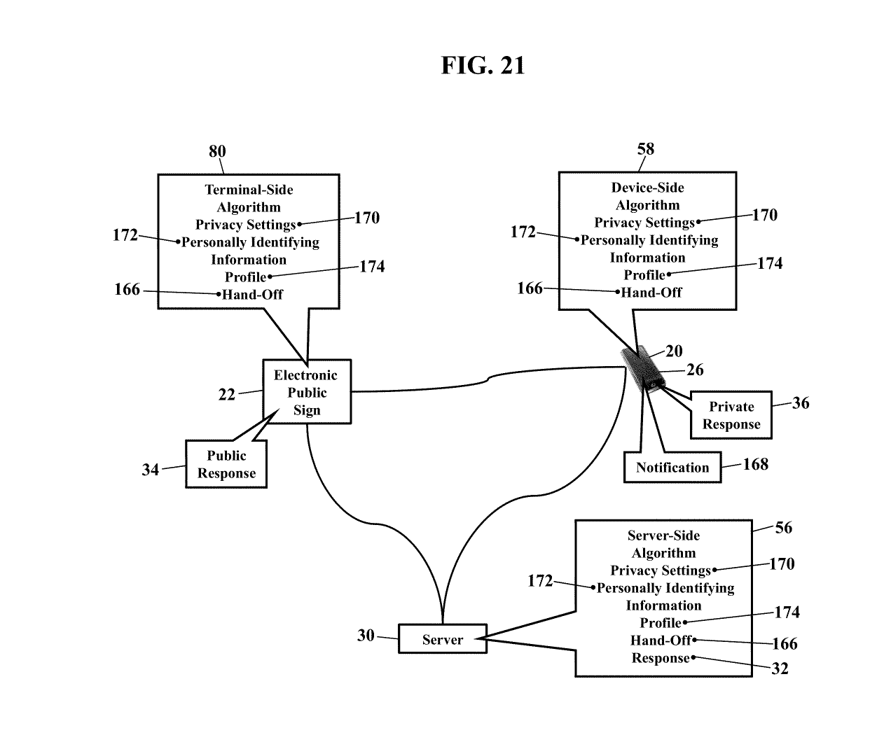

FIG. 21 is a schematic illustrating privacy settings 170, according to exemplary embodiments. Sometimes the content, displayed by the electronic public sign 22, may include personally identifying information 172 that should not be publically displayed. As earlier paragraphs mentioned, some users may not want their name, address, or image publically displayed. Exemplary embodiments, then, may implement the privacy settings 170 to ensure the user's desired privacy is maintained. The device-side algorithm 58, the server-side algorithm 56, and/or the terminal-side algorithm 80, for example, may utilize the dual-formatting to render any content anonymous. The personally identifying information 172, for example, may be excluded and/or removed prior to public display. Names, addresses, images, credit card numbers, relationships, and any other identifying information may be redacted or blocked from public display. A profile 174 may be retrieved (such as from a profile server) that stores the privacy settings 170 associated with the user and/or the mobile device 20. Exemplary embodiments may thus block public presentation of the personally identifying information 172, as specified by the profile 174. Many privacy schemes are known, and exemplary embodiments may be adapted to utilize any privacy scheme. This disclosure, then need not discuss the known schemes.

The hand-off module 166 may again be invoked when the personally identifying information 172 is detected. When public presentation is blocked, the hand-off module 166 may intervene. The hand-off module 166, for example, may redirect any personally identifying information 172 back to the network address of the requesting mobile device 20. The notification 168 may also be sent, informing the user of the mobile device 20 that the personally identifying information 172 failed the privacy settings 170 of the profile 174. The device-side algorithm 58 may then privately display the personally identifying information 172 on the display of the mobile device 20.

Dual-formatting may again be invoked. Whenever the response 32 contains the personally identifying information 172, exemplary embodiments may invoke the dual formatting of the response 32. The public response 34 may be generated without the personally identifying information 172, while the private response 36 may be generated to contain the personally identifying information 172. Again, dual-formatting allows social interaction without compromising the user's personally identifying information 172.

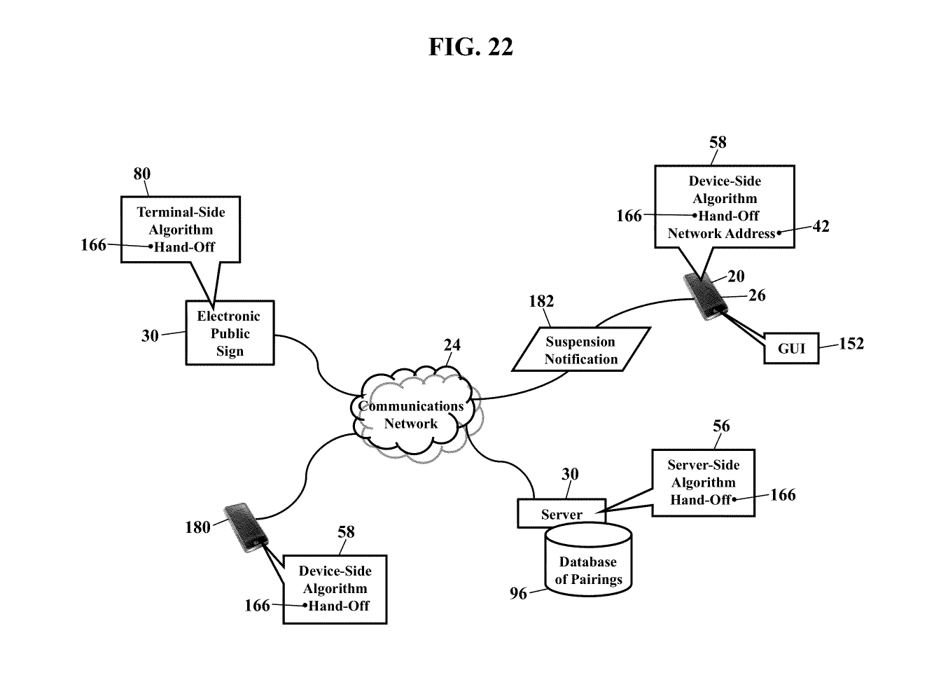

FIG. 22 is a schematic illustrating requested hand-offs, according to exemplary embodiments. The user of the mobile device 20 may also invoke the hand-off module 166 when desired. At any time the user may make some selection that suspends the pairing with the electronic public sign 22. Sometimes, for example, the user may wish to privately communicate with another user at different mobile device 180. The user of the device-side algorithm 58, for example, may thus select a graphical control in the graphical user interface 152. Whatever the input, the device-side algorithm 58 may send a suspension notification 182. The suspension notification 182 includes information that may at least temporarily suspend the pairing between the mobile device 20 and the electronic public sign 22. The suspension notification 182 communicates into the communications network 24 and routes to any destination to affect the hand-off. The suspension notification 182, for example, may be received by the server 30 and/or by the electronic public sign 22. The suspension notification 182 may at least temporarily divorce the pairing in the database 96 of pairings between the mobile device 20 and the electronic public sign 22. The server 30 may return a confirmation to the mobile device 20, thus allowing the mobile device 20 to specify its network address 42 as the destination for communications with the different mobile device 180. Moreover, the server 30 may propagate the divorce through the communications network 24 to ensure routing tables are updated.

Exemplary embodiments may hand-off at will. The server-side algorithm 56, the device-side algorithm 58, and/or the terminal-side algorithm 80 may autonomously determine that a hand-off is desired. Any interaction may move between the electronic public sign 22 and the mobile device 20 at will. For example, to facilitate a financial transaction, or to send the personally identifying information (illustrated as reference numeral 172 in FIG. 21) for a product trial, any interaction may switch to the display of the mobile device 20 alone. Public interactions, like general product viewing, answering frequently asked questions, or generic advertisement playback, can be shown on the electronic public sign 22 and/or the mobile device 20 exclusively or simultaneously.

Hand-offs may also be invoked for other social opportunities. Users may wish to transfer their interactions out of the network 40 of the electronic public signs 22 and to other social media channels (such as the FACEBOOK® website, a TWITTER® SMS text group list, or an email distribution list). This type of hand-off may pull other people into the interactive experience. Hand-offs may also be location-based, such that as the mobile device 20 moves to a different location, the current interaction follows to the next closest electronic public sign 22. That is, exemplary embodiments may leverage social networks from a user's profile and prompt friends to join.

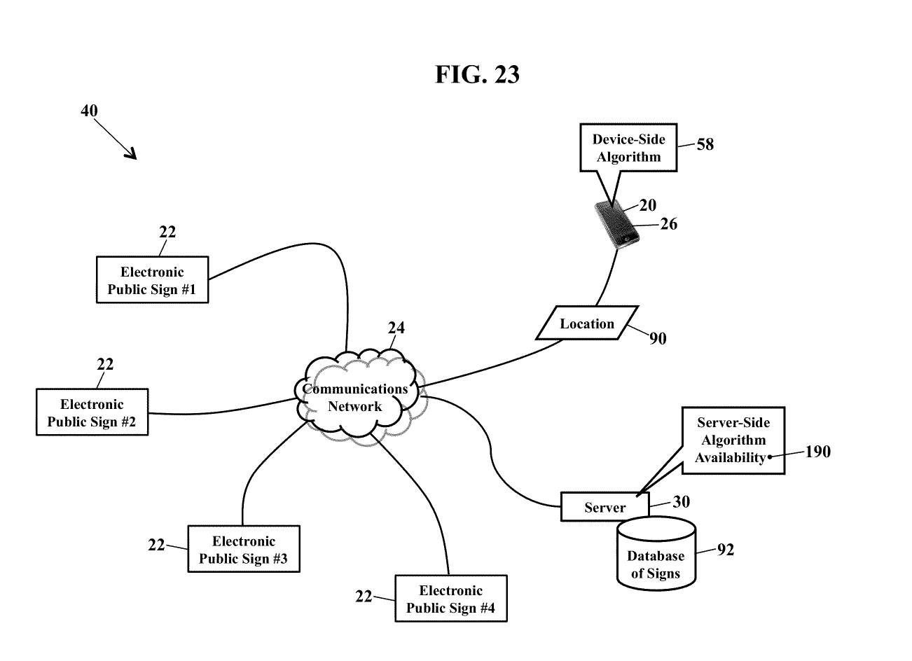

FIG. 23 is a schematic illustrating availability 190, according to exemplary embodiments. Sometimes there may be several electronic public signs 22 in nearly the same location 90 of the mobile device 20. Nanjing Street in Shanghai, China, for example, has many electronic public signs that advertise to shoppers. When the server 30 queries the database 92 of signs for the location 90 of the mobile device 20, the server 30 may retrieve network addresses of multiple electronic public signs 22 that match the location 90 (as explained with reference to FIGS. 9-12). Exemplary embodiments, then, may determine which one of the matching electronic public signs 22 is best available to display content. The server 30, for example, may choose one of the matching electronic public signs 22 having no backlog, or a shortest wait time, in the corresponding queue of responses (illustrated as reference numeral 120 in FIG. 16).

The availability 190, however, may also be determined from other characteristics. Some electronic public signs, for example, may lack sufficient processing capabilities to adequately display video-intensive content. An older electronic public sign, as an example, may lack the processing power, memory, or software to meet the needs of an advertiser. The server 30 may thus determine that a particular electronic public sign 22 is unsuited to some content requirement.

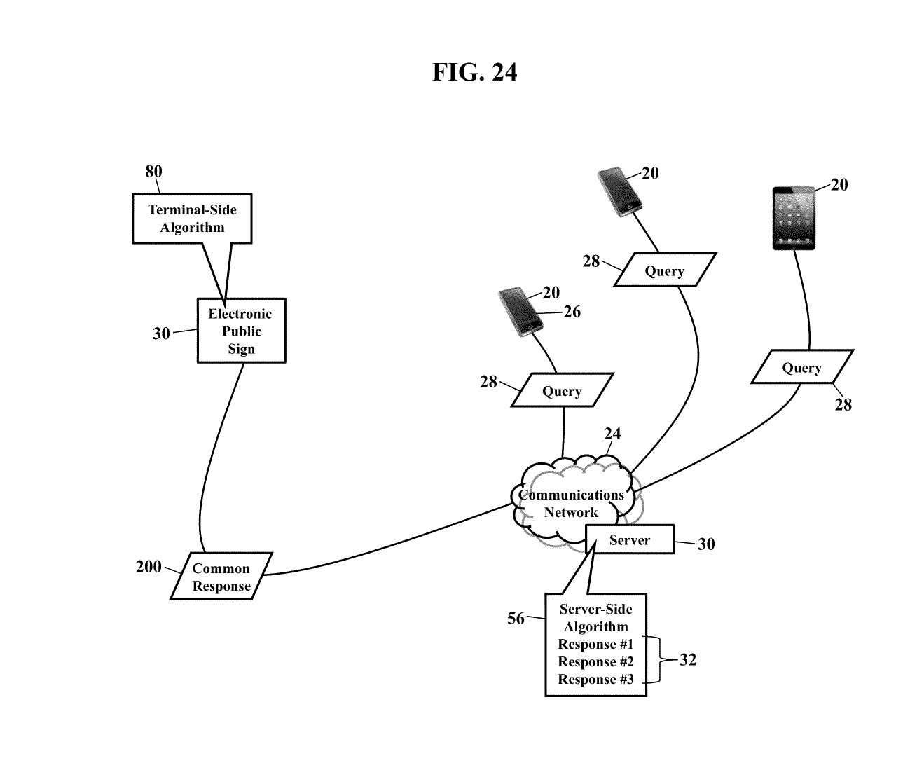

FIG. 24 is a schematic illustrating a common response 200, according to exemplary embodiments. As there may be many mobile devices 20 interacting with the electronic public sign 22, some users will inevitably submit similar queries 28. In a crowd of people, for example, several mobile devices 20 will likely submit queries for weather information. The electronic public sign 22 may thus display a weather forecast as the common response 200 for the similar queries 28. Indeed, many people may submit nearly simultaneous queries 28 for sports scores, stock scores, news events, and other popular, trending topics. The single, common response 200 may thus suffice for many similar queries 28.

Exemplary embodiments may thus determine the common response 200. As the multiple queries 28 are received, the server-side algorithm 56 may determine that the one common response 200 suffices for the multiple queries 28. Exemplary embodiments, for example, may compare text in fields of the multiple responses 32 for matches. Should one or more of the responses 32 contain matching text, the server-side algorithm 56 may determine that the single, common response 200 suffices. More sophisticated language parsing of the queries 28 may be used to determine similar content or intent. Regardless, the single, common response 200 may thus be routed to the electronic public sign 22 for display in response to the multiple queries 28. The single, common response 200 thus saves processing and network resources and, yet, still interacts with several users.

Exemplary embodiments may also inspect the multiple queries 28. As the multiple queries 28 are processed, exemplary embodiments may additionally or alternatively compare the text in the fields of the multiple queries 28. Should one or more of the queries 28 contain matching text or subject matter, exemplary embodiments may retrieve, process, and/or route the single, common response 200. The server-side algorithm 56, for example, may provide instructions to have the single, common response 200 routed to the electronic public sign 22 for display in response to the multiple queries 28. The single, common response 200 again saves processing and network resources.

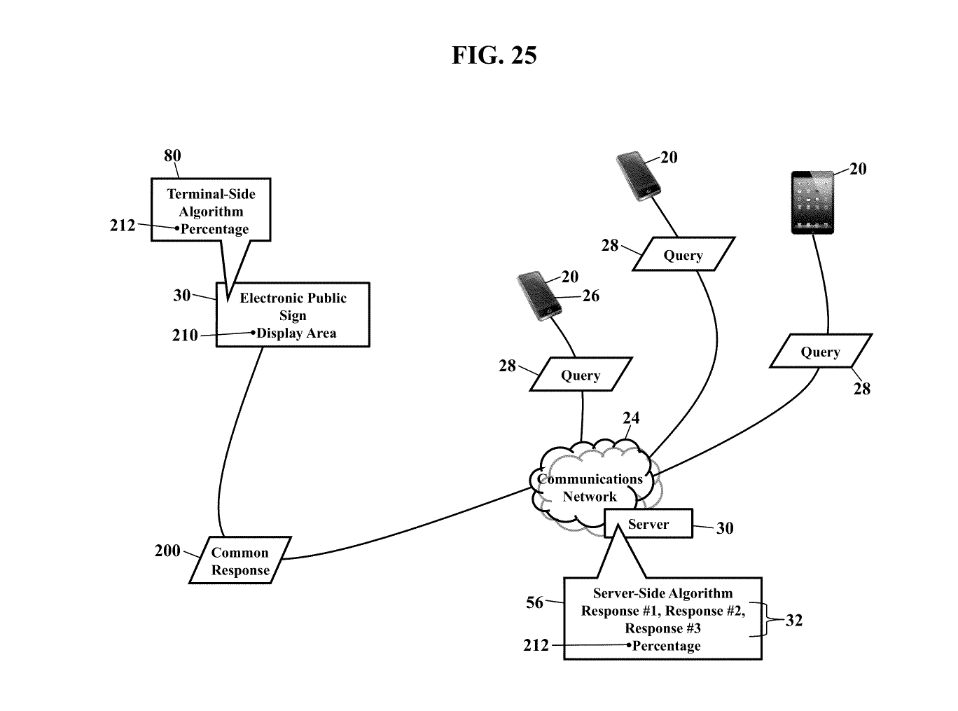

FIGS. 25-27 are schematics further illustrating the common response 200, according to exemplary embodiments. Here the common response 200 may be sized for display according to the number of mobile devices 20 submitting the similar queries 28. Assume one hundred (100) queries are submitted, and fifty (50) of those queries are determined to require the single, common response 200. That is, fifty percent (50%) of the queries 28, perhaps at a particular moment in time, may be answered with the single, common response 200. Exemplary embodiments may thus cause the electronic public sign 22 to display the single, common response 200. Yet, as 50% of the queries 28 deserve the same or similar interaction, exemplary embodiments may cause the electronic public sign 22 to size the single, common response 200 at 50% of a display area 210. The display area 210 may be determined by square inches/millimeters, diagonal length, horizontal and/or vertical pixels, or any other measure. However the display area 210 is determined, exemplary embodiments may determine a percentage 212 of the queries having the single, common response 200 and then display the single, common response 200 sized to the same percentage 212 of the display area 210 available on the electronic public sign 22. In this example, then, half of the display area 210 of the electronic public sign 22 is consumed by the common response 200.

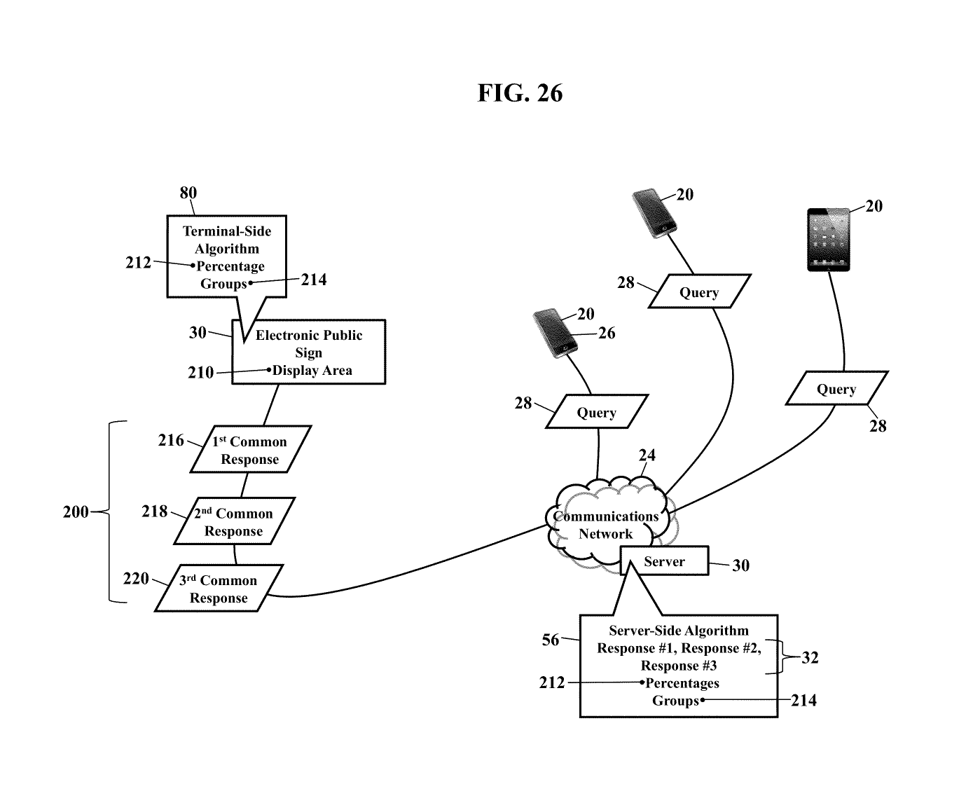

FIG. 26 extends common responses to an entire population of the queries 28. Exemplary embodiments may determine that multiple groups 214 of the queries 28 deserve different, but corresponding, common responses 200. Suppose, again, that one hundred (100) queries 28 are received within a period of time (such as within one minute). Half of the queries (50%) are determined to deserve a first common response 216. Perhaps another thirty percent (30%) of the queries 28 deserve a different, second common response 218. Still a smaller ten percent (10%) of the queries 28 may require a third common response 220. Whatever the percentage 212 of the groupings 214, exemplary embodiments may size each different common response 200 according to its corresponding percentage 212 of the query population. In other words, the most common response 200 to a very popular query 28 is thus sized for display in a larger font that lesser popular queries 28. Each common response 200 may thus be sized to its corresponding percentage 212 of the display area 210.

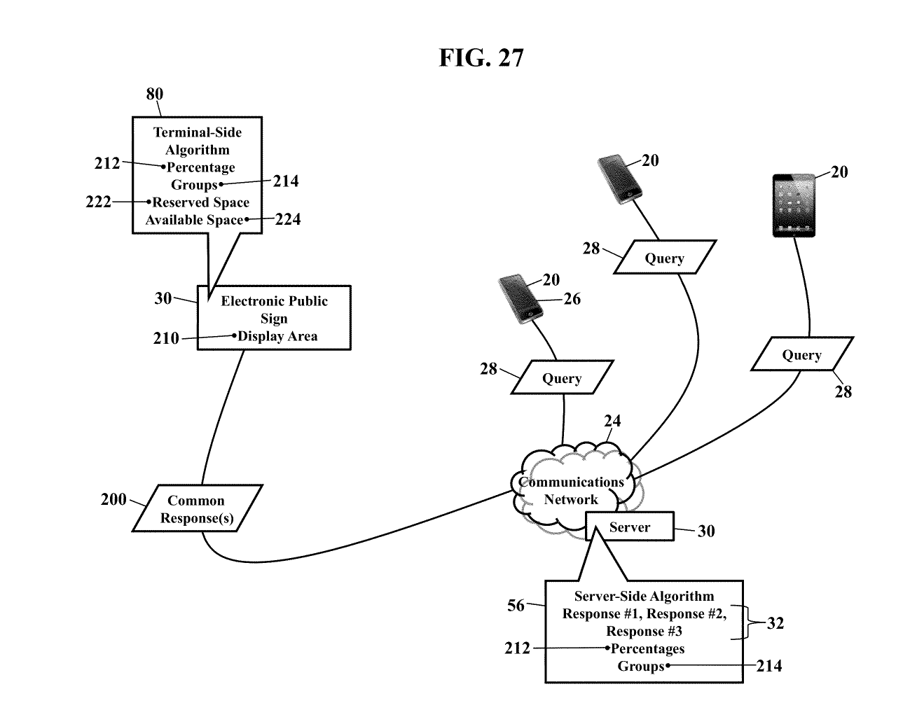

FIG. 27 illustrates reserved display space 222. Exemplary embodiments may reserve some quadrants, pixels, or portions of the display area 210 for advertising. Even though users may submit their queries 28, perhaps 50% of the display area 210 of the electronic public sign 22 may be reserved for advertising opportunities. So, whatever the percentage 212 groupings of the common responses 32, only some of the display area 210 may be available. Whatever an available display space 224, each common response 200 may thus be sized to its corresponding percentage 212 of the available display space 224.

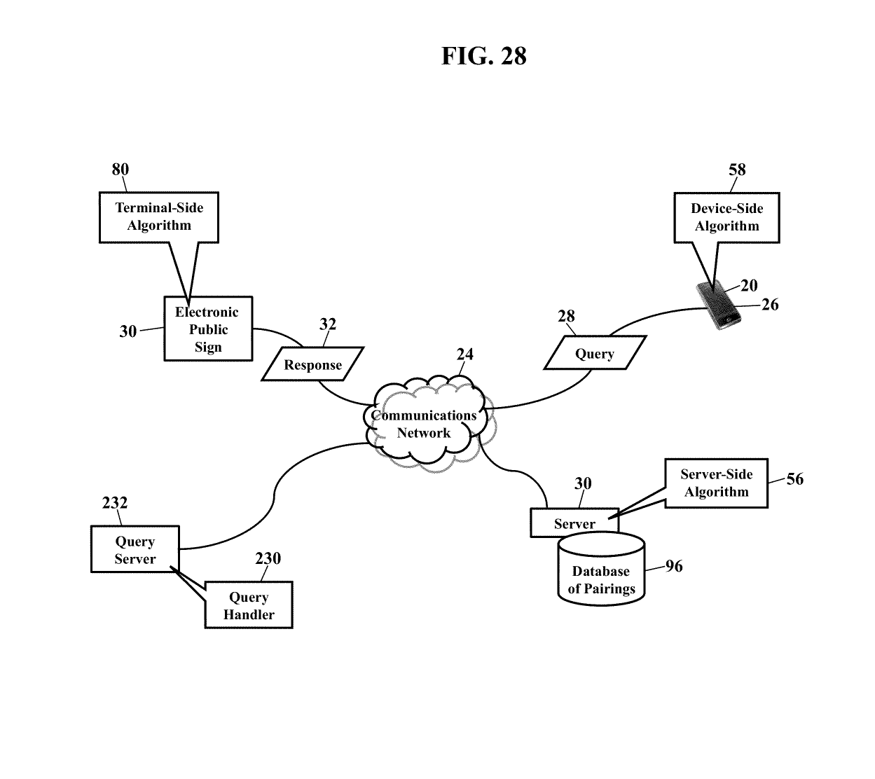

FIG. 28 is a schematic illustrating an alternate operating environment, according to exemplary embodiments. Here the mobile device 20 submits its query 28, but the response 32 need not route through the server 30. Once the server 30 pairs the mobile device 20 with the electronic public sign 22 (as explained with reference to the database 96 of pairings), the server 30 need not process the query 28 and the corresponding response 32. Instead, once the pairing is established, the mobile device 20 may send the query 28 to a network address associated with a query handler 230. The query handler 230 is any software operating in a query server 232 that determines or obtains the response 32 to the query 28. Once the response 32 is determined, the query handler 230 is instructed to send the response 32 to the paired electronic public sign 22. Here, then, the server 30 is not burdened with processing the queries 28 and responses 32.

Exemplary embodiments may be applied to home networks. As friends gather within a home, the friends may wish to interact in front of a wide-screen display. The users may thus socially interact on the wide-screen display using a residential local area network. A gateway server in the residential local area network may pair each mobile device 20 with the wide-screen display. The users may thus submit their queries 28, and the corresponding responses 32 are displayed by the wide-screen display. Exemplary embodiments may thus be applied to residential networks such that the responses 32 are redirected to the network address 42 associated with the wide-screen display.

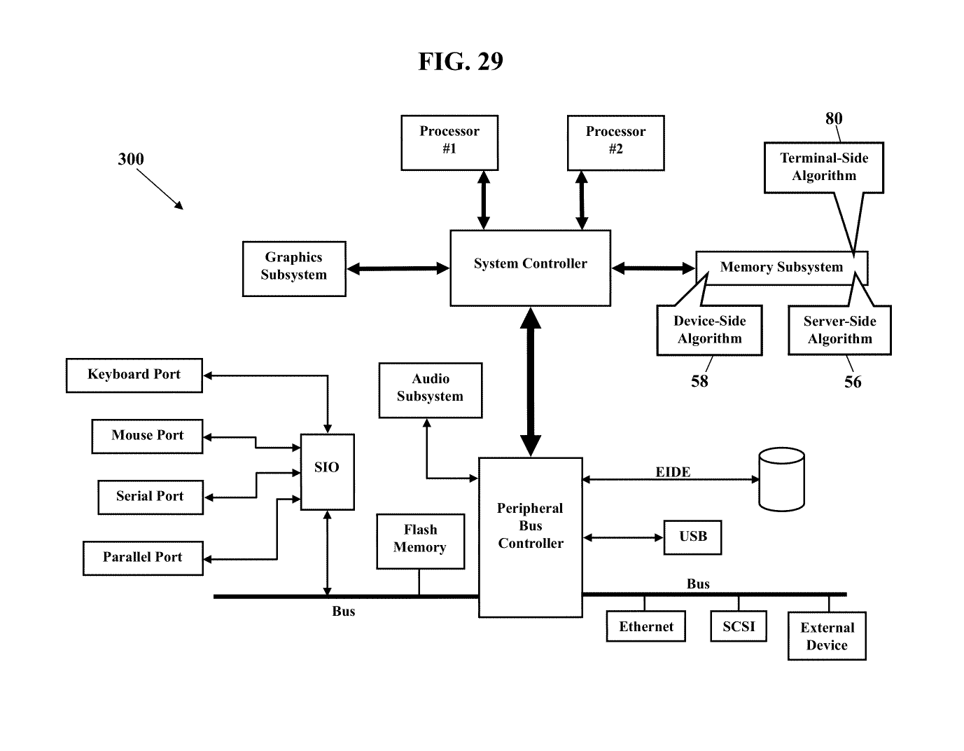

FIG. 29 is a schematic illustrating still more exemplary embodiments. FIG. 29 is a more detailed diagram illustrating a processor-controlled device 300. As earlier paragraphs explained, the server-side algorithm 56, the device-side algorithm 58, and/or the terminal-side algorithm 80 may operate in any processor-controlled device. FIG. 29, then, illustrates the server-side algorithm 56, the device-side algorithm 58, and/or the terminal-side algorithm 80 stored in a memory subsystem of the processor-controlled device 300. One or more processors communicate with the memory subsystem and execute either, some, or all applications. Because the processor-controlled device 300 is well known to those of ordinary skill in the art, no further explanation is needed.

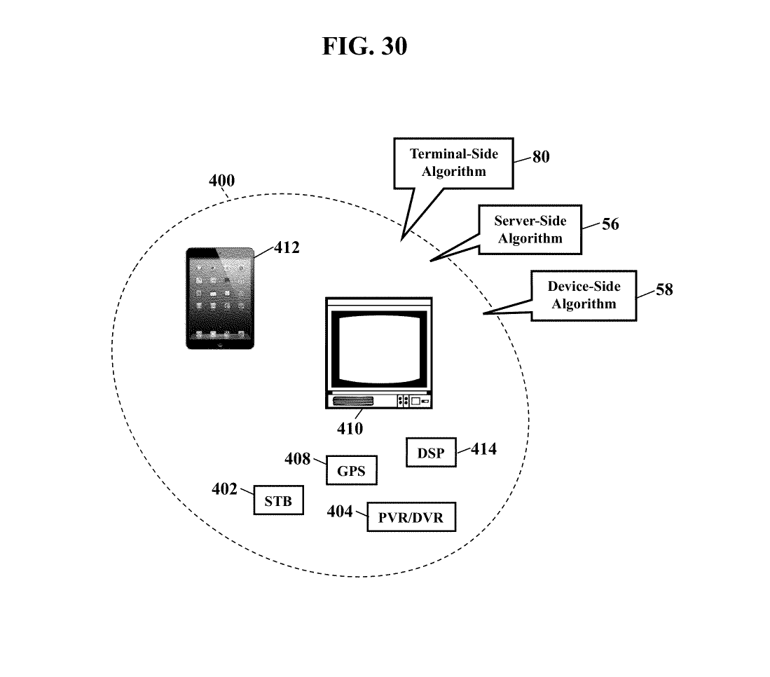

FIG. 30 depicts other possible operating environments for additional aspects of the exemplary embodiments. FIG. 30 illustrates the server-side algorithm 56, the device-side algorithm 58, and/or the terminal-side algorithm 80 operating within various other devices 400. FIG. 30, for example, illustrates that the server-side algorithm 56, the device-side algorithm 58, and/or the terminal-side algorithm 80 may entirely or partially operate within a set-top box (“STB”) (402), a personal/digital video recorder (PVR/DVR) 404, a Global Positioning System (GPS) device 408, an interactive television 410, a tablet computer 412, or any computer system, communications device, or processor-controlled device utilizing the processor 50 and/or a digital signal processor (DP/DSP) 414. The device 400 may also include watches, radios, vehicle electronics, clocks, printers, gateways, mobile/implantable medical devices, and other apparatuses and systems. Because the architecture and operating principles of the various devices 400 are well known, the hardware and software componentry of the various devices 400 are not further shown and described.

Exemplary embodiments may be physically embodied on or in a computer-readable storage medium. This computer-readable medium, for example, may include CD-ROM, DVD, tape, cassette, floppy disk, optical disk, memory card, memory drive, and large-capacity disks. This computer-readable medium, or media, could be distributed to end-subscribers, licensees, and assignees. A computer program product comprises processor-executable instructions for public interactions with mobile devices, as the above paragraphs explained.

While the exemplary embodiments have been described with respect to various features, aspects, and embodiments, those skilled and unskilled in the art will recognize the exemplary embodiments are not so limited. Other variations, modifications, and alternative embodiments may be made without departing from the spirit and scope of the exemplary embodiments.

What is claimed is:

1. A method, comprising:
receiving, at a server, queries sent from a plurality of mobile devices;
retrieving responses to the queries;
determining an electronic public sign that is common to the queries;
retrieving a network address associated with the electronic public sign;
sending the responses from the server to the network address associated with the electronic public sign; and
sending a display instruction from the server to the network address to display the responses on the electronic public sign.

2. The method of claim 1, further comprising:
determining a single response is common to multiple ones of the queries; and
instructing the electronic public sign to display the single response,
wherein the single response is publically displayed in response to the multiple ones of the queries.

3. The method of claim 2, further comprising:
determining a percentage of the queries having the single response;
instructing the electronic public sign to display the single response sized to the percentage of a display area.

4. The method of claim 1, further comprising determining one of the responses contains personal information.

5. The method of claim 4, further comprising removing the personal information prior to the display on the electronic public sign.

6. The method of claim 4, further comprising excluding the one of the responses from the display on the electronic public sign.

7. The method of claim 6, further comprising:
determining which one of the queries corresponds to the one of the responses containing the personal information;
determining an address from which the one of the queries originated; and
sending the one of the responses containing the personal information to the address,
wherein the one of the responses containing the personal information is received by a corresponding one of the plurality of mobile devices to prevent public display of the personal information.

8. A system, comprising:
a processor; and
memory storing instructions that when executed cause the processor to perform operations, the operations comprising:
receiving queries sent from a plurality of mobile devices;
retrieving responses to the queries;
determining an electronic public sign that is common to the queries;
retrieving a network address associated with the electronic public sign;
sending the responses to the network address associated with the electronic public sign; and
sending a display instruction to the network address to display the responses on the electronic public sign.

9. The system of claim 8, wherein the operations further comprise:
determining a single response is common to multiple ones of the queries; and
instructing the electronic public sign to display the single response,
wherein the single response is publically displayed in response to the multiple ones of the queries.

10. The system of claim 9, wherein the operations further comprise:
determining a percentage of the queries having the single response;
instructing the electronic public sign to display the single response sized to the percentage of a display area.

11. The system of claim 8, wherein the operations further comprise determining one of the responses contains personal information.

12. The system of claim 11, wherein the operations further comprise removing the personal information prior to the display on the electronic public sign.

13. The system of claim 11, wherein the operations further comprise excluding the one of the responses from the display on the electronic public sign.

14. The system of claim 13, wherein the operations further comprise:
determining which one of the queries corresponds to the one of the responses containing the personal information;
determining an address from which the one of the queries originated; and
sending the one of the responses containing the personal information to the address,
wherein the one of the responses containing the personal information is received by a corresponding one of the plurality of mobile devices to prevent public display of the personal information.

15. A memory storing instructions that when execute cause a processor to perform operations, the operations comprising:
receiving, at a server, a query sent from a mobile device;
retrieving a response to the query;
dual-formatting the response to generate a public response and a private response for different destinations;
retrieving a network address of an electronic public sign that is associated with the network address of the mobile device;
sending the public response from the server to the network address associated with the electronic public sign for public display; and
sending the private response from the server to the network address of the mobile device for private consumption.

16. The memory of claim 15, wherein the operations further comprise removing personal information from the public response prior to the public display.

17. The memory of claim 15, wherein the operations further comprise processing the public response to suit capabilities of the electronic public display.

18. The memory of claim 15, wherein the operations further comprise processing the private response to suit capabilities of the mobile device.

19. The memory of claim 15, wherein the operations further comprise sanitizing the public response for the public display.

20. The memory of claim 15, wherein the operations further comprise sending a display instruction from the server to the network address associated with the electronic public sign.
